(19) United States
(12) Patent Application Publication
(10) Pub. No.: US 2025/0312794 A1
(43) Pub. Date: Oct. 9, 2025

(54) MULTI-VOLUME VIAL APPARATUS WITH CLOSURE AND SEAL

(71) Applicant: JG Finneran Associates, Inc., Vineland, NJ (US)

(72) Inventors: Don Davin Horner, West Deptford, NJ (US); Sandra Finneran Hitchner, Margate, NJ (US)

(21) Appl. No.: 18/626,356

(22) Filed: Apr. 4, 2024

(51) Int. Cl. B01L 3/00

(52) U.S. Cl. CPC B01L 3/50853; B01L 2200/0689; B01L 2300/044; B01L 2300/0803; B01L 2300/0832

(57) ABSTRACT

A multi-volume vial apparatus includes a container with a collar, a septa member, and a closure. At least one interior wall partitions an opening of the collar and an inner volume of the container into separate wells. The septa member, enclosed within the closure and disposed on the collar of the container, seals and maintains separation of the wells. At least two opposing protruding sections extending downwardly from a lower surface of the septa member fit securely within the partitioned opening of the collar of the container. The opposing protruding sections define a groove therebetween that firmly receives the top end of the interior wall. Locking members disposed inside the closure engage with locking members on the collar of the container to lock the container. A protruding element, attached to a bottom end of the container, engages with a receptacle of automated laboratory equipment for precluding rotation of the container.

### BACKGROUND

To automate the process of sampling in a short amount of time, meet the needs of quality control, and simplify the process of measuring and analyzing multiple samples in analytical chemical and medical laboratories, automatic samplers, also referred to as “autosamplers”, are used along with analytical instruments. An autosampler automatically and reproducibly delivers a vial containing a sample to an analytical instrument configured to analyze the sample. The autosampler typically comprises, for example, a tray for storing multiple vials containing samples, a mechanism for collecting a sample, a mechanism for transporting the sample from the tray to the analytical instrument, and a device for cleaning the sample collecting mechanism. The autosampler allows for fully automatic sequential measurement of, for example, up to 30 dry or liquid samples. A user needs to load a predefined amount of a sample in a vial and place the vial in a rack. The autosampler automates the process of introducing a sample into the analytical instrument, thereby reducing the need for manual intervention, which improves efficiency and reduces the potential for human error. The autosampler delivers small and consistent sample volumes to the analytical instrument, leading to more accurate and reproducible results compared to manual sampling methods. The autosampler preserves the integrity of each sample by minimizing exposure to air and contaminants during the sampling process. By automating the sampling process, the autosampler substantially increases the throughput of analytical instruments, while facilitating different applications comprising, for example, powder dispensing, viscous media dispensing, weighing, potential of hydrogen (pH) measurement and adjustment, vortexing, magnetic stirring, overhead stirring, sonication, sample purification, high-performance or high-pressure liquid chromatography (HPLC) or liquid chromatography-mass spectrometry (LC-MS) applications, etc.

However, each vial used in the sampling process typically defines a single inner volume for storing a single sample and allows for a single analysis to be performed within the same vial. The sampling process with a single-volume vial produces a reduced throughput in a substantial amount of time and requires more tedious handling of multiple vials for analyzing multiple samples. Moreover, to prevent leakage from a vial, a cap is typically screwed, snapped, or frictionally fitted onto the vial, which makes it difficult to close the vial or remove the cap from the vial during the sampling process. Furthermore, screw threads of conventional vials cause the caps to be over or under tightened on the vials causing height differences when assembled and also causing misalignment or misorientation of seal ports of the caps, making it difficult for probe heads of automated laboratory equipment to identify locations of the seal ports to perform different operations for a sample analysis. Furthermore, conventional vials are typically covered with solid top caps that do not provide any visual indication of the locations of the openings in the vials.

Furthermore, to prevent leakage of a sample from a vial, a leak-proof seal is typically provided between the cap and the top end of the vial. However, this leak-proof seal is typically displaced during closure and removal of the cap of the vial, which may lead to contamination of the sample and loss of material required in an analysis, thereby altering qualitative and/or quantitative results of the analysis. There is a need for a grippable and pierceable closure and a lock mechanism that allow convenient closure and access to multiple samples in a single vial without displacing the leak-proof seal from the top end of the vial.

Moreover, conventional vials are typically not securely held within a conventional tray of an autosampler, thereby resulting in the vials turning and increasing difficulty in performing different operations on the vials, for example, placing caps on the vials, removing the caps from the vials, applying labels such as barcode labels on the vials, reading labels on the vials, etc. Furthermore, conventional vials do not provide any indication of the locations and the orientation of the openings of the vials within the tray, thereby making it difficult for automated laboratory equipment probes to accurately access the samples contained therein, which reduces the throughput of the sampling process. Therefore, there is a need for a securing mechanism that securely positions and holds a vial within the tray during performance of different operations on the vial and that indicates the locations and the orientation of the openings of the vial and presents internal volumes of the vial for convenient access by automated laboratory equipment probes, for example, during a sampling process.

Hence, there is a long-felt need for a multi-volume vial apparatus internally partitioned to accommodate more than one volume for storing more than one sample, thereby allowing multiple parallel analyses and parallel syntheses of multiple samples to be performed within a single vial in a single operation, and allowing the throughput to be increased with less handling in less time, while addressing the above-disclosed problems and needs of the related art.

### BRIEF DESCRIPTION OF THE DRAWINGS

The following detailed description of the invention is better understood when read in conjunction with the appended drawings. For illustrating the embodiments herein, exemplary constructions of the embodiments are shown in the drawings. However, the embodiments herein are not limited to the specific components, structures, and methods disclosed herein. In an embodiment, various structural elements are employed depending on design choices of a system designer. The description of a component, or a structure, or a method step referenced by a numeral in a drawing is applicable to the description of that component, or structure, or method step shown by that same numeral in any subsequent drawing herein. The terms “front”, “rear”, “side”, “top”, “bottom”, “upper”, “lower”, “inner”, “outer”, “interior”, etc., are based on an orientation or a positional relationship shown in the appended drawings, and are recited merely for describing the embodiments herein, rather than indicating or implying that the device, component, or structure referenced must have a particular orientation or position or must be constructed and operated in a particular orientation, and therefore should not be construed as limiting the embodiments herein.

FIG. 1A illustrates an exploded, top perspective view of an embodiment of a multi-volume vial apparatus.

FIG. 1B illustrates an exploded, bottom perspective view of the embodiment of the multi-volume vial apparatus shown in FIG. 1A.

FIG. 1C illustrates an exploded, front elevation view of the embodiment of the multi-volume vial apparatus shown in FIG. 1A.

FIG. 1D illustrates an exploded, right-side elevation view of the embodiment of the multi-volume vial apparatus shown in FIG. 1A.

FIG. 2 illustrates an assembled, front elevation view of the embodiment of the multi-volume vial apparatus shown in FIG. 1A.

FIG. 3A illustrates a top perspective view of an embodiment of a container of the multi-volume vial apparatus shown in FIG. 1A.

FIG. 3B illustrates a bottom perspective view of the embodiment of the container shown in FIG. 3A.

FIG. 3C illustrates a front elevation view of the embodiment of the container shown in FIG. 3A.

FIG. 3D illustrates a cross-sectional view of the embodiment of the container shown in FIG. 3A, taken along a sectional line A-A shown in FIG. 3C.

FIG. 3E illustrates a top plan view of the embodiment of the container shown in FIG. 3A.

FIG. 3F illustrates a bottom elevation view of the embodiment of the container shown in FIG. 3A.

FIG. 3G illustrates a right-side elevation view of the embodiment of the container shown in FIG. 3A.

FIG. 3H illustrates a cross-sectional, elevation view of the embodiment of the container shown in FIG. 3A, taken along a sectional line B-B shown in FIG. 3G.

FIG. 3I illustrates a cross-sectional, perspective view of the embodiment of the container shown in FIG. 3A, taken along the sectional line B-B shown in FIG. 3G.

FIG. 4A illustrates a top plan view of another embodiment of the container of the multi-volume vial apparatus.

FIG. 4B illustrates a cross-sectional, elevation view of the embodiment of the container shown in FIG. 4A, taken along a sectional line C-C shown in FIG. 4A.

FIG. 4C illustrates a cross-sectional, perspective view of the embodiment of the container shown in FIG. 4A, taken along the sectional line C-C shown in FIG. 4A.

FIG. 5A illustrates a top plan view of another embodiment of the container of the multi-volume vial apparatus.

FIG. 5B illustrates a cross-sectional, elevation view of the embodiment of the container shown in FIG. 5A, taken along a sectional line D-D shown in FIG. 5A.

FIG. 5C illustrates a cross-sectional, perspective view of the embodiment of the container shown in FIG. 5A, taken along the sectional line D-D shown in FIG. 5A.

FIG. 6A illustrates a top plan view of another embodiment of the container of the multi-volume vial apparatus.

FIG. 6B illustrates a cross-sectional, elevation view of the embodiment of the container shown in FIG. 6A, taken along a sectional line E-E shown in FIG. 6A.

FIG. 6C illustrates a cross-sectional, perspective view of the embodiment of the container shown in FIG. 6A, taken along the sectional line E-E shown in FIG. 6A.

FIG. 7A illustrates a top perspective view of an embodiment of a closure of the multi-volume vial apparatus shown in FIG. 1A.

FIG. 7B illustrates a bottom perspective view of the embodiment of the closure shown in FIG. 7A.

FIG. 7C illustrates a front elevation view of the embodiment of the closure shown in FIG. 7A, the rear elevation view, the right-side elevation view, and the left-side elevation view being mirror images thereof.

FIG. 7D illustrates a top plan view of the embodiment of the closure shown in FIG. 7A.

FIG. 7E illustrates a cross-sectional view of the embodiment of the closure shown in FIG. 7A, taken along a sectional line F-F shown in FIG. 7D.

FIG. 7F illustrates a cross-sectional view of the embodiment of the closure shown in FIG. 7A, taken along a sectional line G-G shown in FIG. 7D.

FIG. 7G illustrates a bottom elevation view of the embodiment of the closure shown in FIG. 7A.

FIG. 8A illustrates a top perspective view of another embodiment of the closure.

FIG. 8B illustrates a top plan view of the embodiment of the closure shown in FIG. 8A.

FIG. 8C illustrates a cross-sectional view of the embodiment of the closure shown in FIG. 8A, taken along a sectional line H-H shown in FIG. 8B.

FIG. 9 illustrates a top perspective view of another embodiment of the closure.

FIG. 10A illustrates a top perspective view of an embodiment of a septa member of the multi-volume vial apparatus shown in FIG. 1A.

FIG. 10B illustrates a bottom perspective view of the embodiment of the septa member shown in FIG. 10A.

FIG. 10C illustrates a top plan view of the embodiment of the septa member shown in FIG. 10A.

FIG. 10D illustrates a cross-sectional view of the embodiment of the septa member shown in FIG. 10A, taken along a sectional line I-I shown in FIG. 10C.

FIG. 10E illustrates a cross-sectional view of the embodiment of the septa member shown in FIG. 10A, taken along a sectional line J-J shown in FIG. 10C.

FIG. 10F illustrates a front elevation view of the embodiment of the septa member shown in FIG. 10A.

FIG. 10G illustrates a bottom elevation view of the embodiment of the septa member shown in FIG. 10A.

FIG. 11A illustrates a top perspective view showing an embodiment of the closure of the multi-volume vial apparatus shown in FIG. 1A, enclosing the septa member of the multi-volume vial apparatus.

FIG. 11B illustrates a front elevation view of the embodiment of the closure enclosing the septa member shown in FIG. 11A.

FIG. 11C illustrates a top plan view of the embodiment of the closure enclosing the septa member shown in FIG. 11A.

FIG. 12A illustrates an exploded, top perspective view of a partially assembled, multi-volume vial apparatus.

FIG. 12B illustrates a top plan view of the partially assembled, multi-volume vial apparatus shown in FIG. 12A.

FIG. 12C illustrates a cross-sectional view of the partially assembled, multi-volume vial apparatus shown in FIG. 12A, taken along a sectional line K-K shown in FIG. 12B.

FIG. 12D illustrates a cross-sectional view of the partially assembled, multi-volume vial apparatus shown in FIG. 12A, taken along a sectional line L-L shown in FIG. 12B.

FIG. 12E illustrates a cross-sectional view of the partially assembled, multi-volume vial apparatus shown in FIG. 12A, taken along a sectional line M-M shown in FIG. 12C.

FIG. 12F illustrates a top perspective view showing movement of the closure with the enclosed septa member in a downward direction for placement over a collar of the container of the multi-volume vial apparatus.

FIG. 12G illustrates a bottom perspective view showing the movement of the closure with the enclosed septa member in the downward direction for placement over the collar of the container of the multi-volume vial apparatus.

FIG. 12H illustrates a front elevation view showing the movement of the closure with the enclosed septa member in the downward direction for placement over the collar of the container of the multi-volume vial apparatus.

FIG. 13A illustrates a top perspective view of the embodiment of the multi-volume vial apparatus shown in FIG. 1A, showing the placement of the closure with the enclosed septa member over the collar of the container.

FIG. 13B illustrates a right-side elevation view of the embodiment of the multi-volume vial apparatus shown in FIG. 13A, showing the placement of the closure with the enclosed septa member over the collar of the container.

FIGS. 13C-13D illustrate a front elevation view and a rear elevation view of the embodiment of the multi-volume vial apparatus shown in FIG. 13A, respectively, showing locking members of the placed closure seated in notches of the collar of the container.

FIG. 14A illustrates a top perspective view of the embodiment of the multi-volume vial apparatus shown in FIG. 1A, showing rotation of the closure over the collar of the container for locking the container without displacement of the septa member on the collar of the container.

FIG. 14B illustrates a front elevation view of the embodiment of the multi-volume vial apparatus shown in FIG. 14A, showing the rotation of the closure over the collar of the container for locking the container without displacement of the septa member on the collar of the container.

FIG. 14C illustrates a front elevation view of the embodiment of the multi-volume vial apparatus shown in FIG. 1A, showing the closure with the securely fit septa member, in a locked condition on the collar of the container.

FIGS. 14D-14E illustrate a left-side elevation view and a right-side elevation view of the embodiment of the multi-volume vial apparatus shown in FIG. 14C, respectively, showing the closure with the securely fit septa member, in the locked condition, and with second locking members of the closure engaged with first locking members on the collar of the container.

FIG. 15 illustrates a top perspective view of an embodiment of an automated laboratory assembly, showing an exploded, top perspective view of the embodiment of the multi-volume vial apparatus shown in FIG. 1A.

FIG. 16A illustrates a top perspective view of an embodiment of a plate member of the automated laboratory assembly shown in FIG. 15.

FIG. 16B illustrates a front elevation view of the embodiment of the plate member shown in FIG. 16A.

FIG. 16C illustrates a top plan view of the embodiment of the plate member shown in FIG. 16A.

FIG. 16D illustrates a cross-sectional view of the embodiment of the plate member shown in FIG. 16A, taken along a sectional line R-R shown in FIG. 16C.

FIG. 17 illustrates a flowchart of an embodiment of a method for assembling a multi-volume vial apparatus.

### DETAILED DESCRIPTION OF THE INVENTION

The apparatus disclosed herein addresses the above-recited need for a multi-volume vial apparatus internally partitioned to accommodate more than one volume for storing more than one sample, thereby allowing multiple parallel analyses and parallel synthesis of multiple samples to be performed within a single multi-volume vial apparatus in a single operation, and allowing the throughput to be increased with less handling in less time. The parallel analyses and the parallel syntheses comprise, for example, powder handling, weighing, high-performance or high-pressure liquid chromatography (HPLC) analysis, liquid chromatography-mass spectrometry (LC-MS) analysis, microwave-assisted synthesis, catalyst synthesis, cascade synthesis, polymer-assisted synthesis, peptide synthesis, solid and solution phase synthesis, sonication, potential of hydrogen (pH) measurement, pH adjustments, etc. The multi-volume vial apparatus provides a grippable and pierceable closure and a lock mechanism that allow convenient closure and access to multiple samples in the single multi-volume vial apparatus without displacing a septa member that is configured to seal a container of the multi-volume vial apparatus, from a top end of the container. The lock mechanism also provides a uniform height to each of multiple multi-volume vial apparatuses in automated laboratory equipment, when assembled, and also precludes misalignment or misorientation of openings of the respective closures, thereby allowing probe heads of the automated laboratory equipment to easily identify the location of the openings to perform different operations on each of the multi-volume vial apparatuses for a sample analysis. The closure of the multi-volume vial apparatus provides a visual indication of a partition and locations of separate volumes in the container, thereby allowing a user or the automated laboratory equipment to identify where the separate volumes lie in the container.

Furthermore, the multi-volume vial apparatus provides a securing mechanism at a bottom end of the container that securely positions and holds the container within a receptacle in a plate member of automated laboratory equipment during performance of different operations on the container and that indicates locations and orientation of openings of the multi-volume vial apparatus and presents internal volumes of the multi-volume vial apparatus for convenient access by automated laboratory equipment probes, for example, during a sampling process. For purposes of illustration, the disclosure herein refers to a multi-volume vial apparatus comprising a container partitioned by a single interior wall into two separate wells for containing samples of the same type or different types; however the scope of the multi-volume vial apparatus disclosed herein is not limited to a dual-volume vial apparatus with a dual-welled container for containing two samples, but extends to include a multi-volume vial apparatus comprising a container partitioned by multiple interior walls into more than two separate wells, for example, three separate wells, four separate wells, or any number of separate wells, for containing more than two samples.

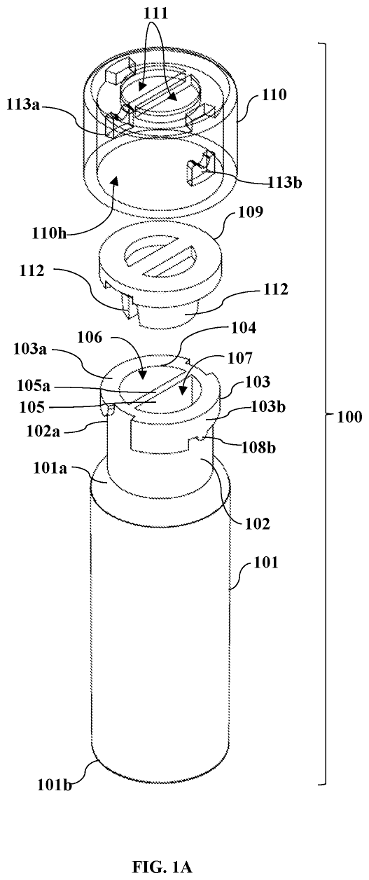

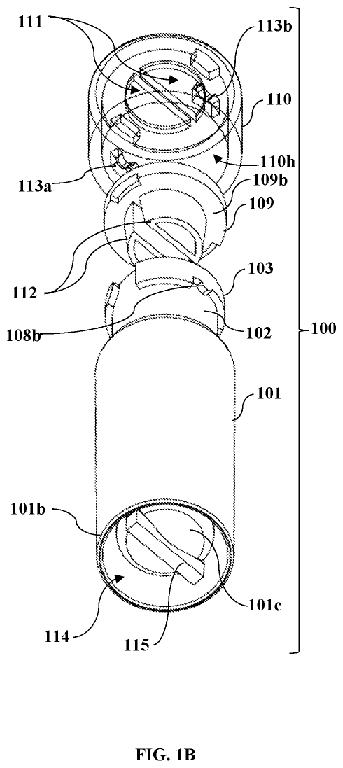

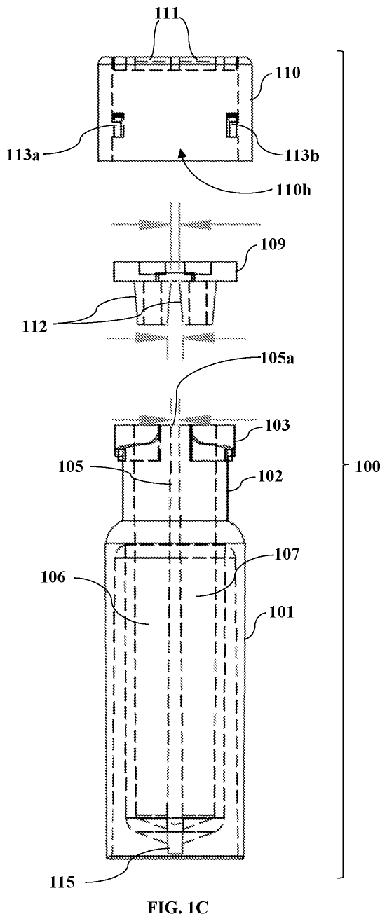

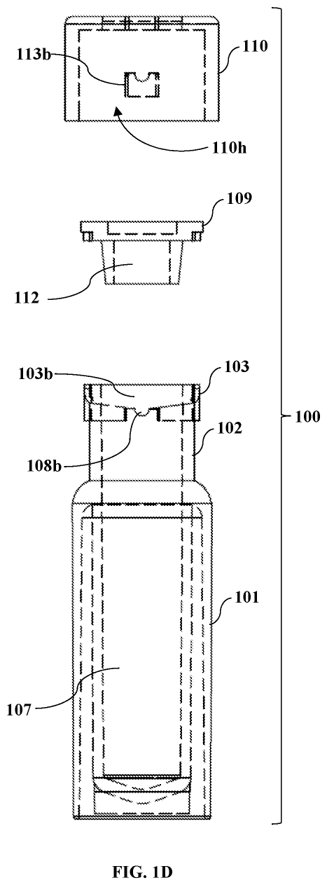

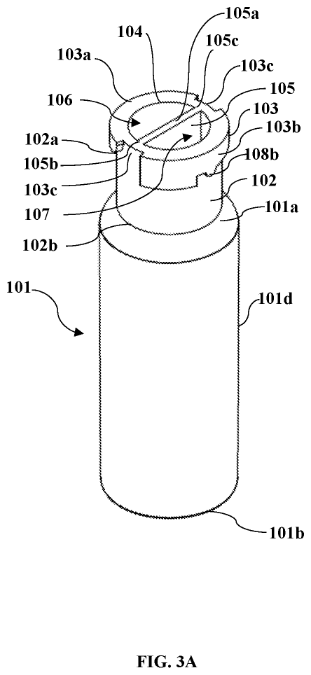

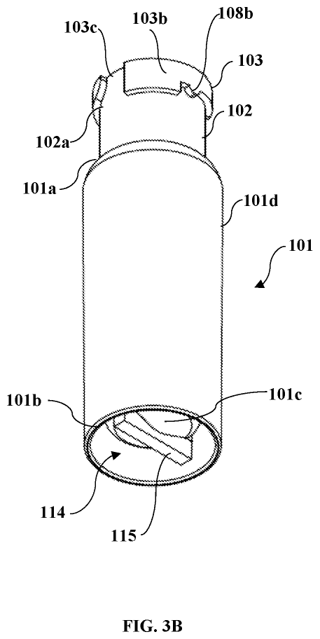

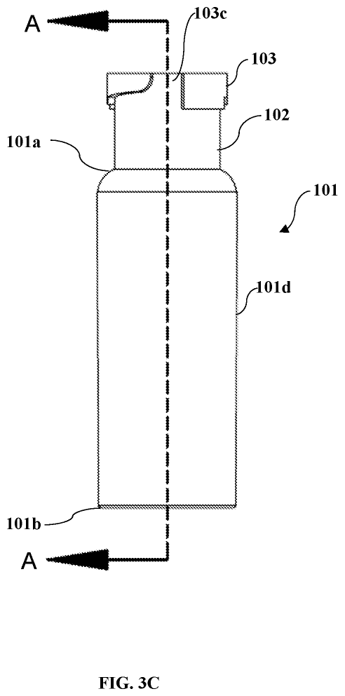

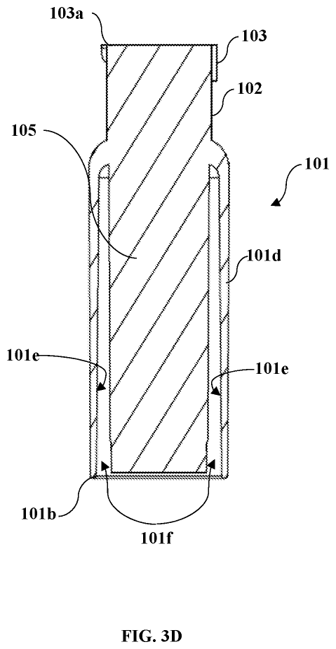

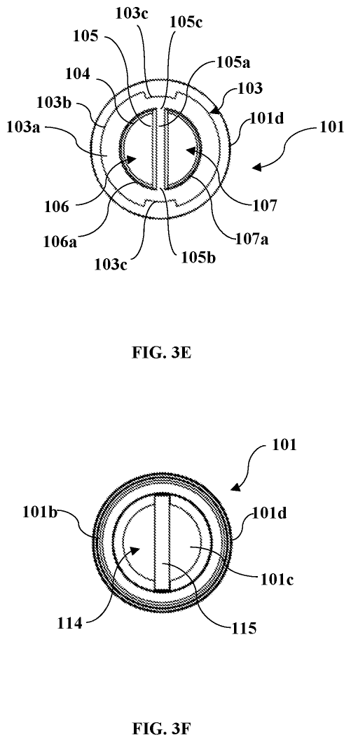

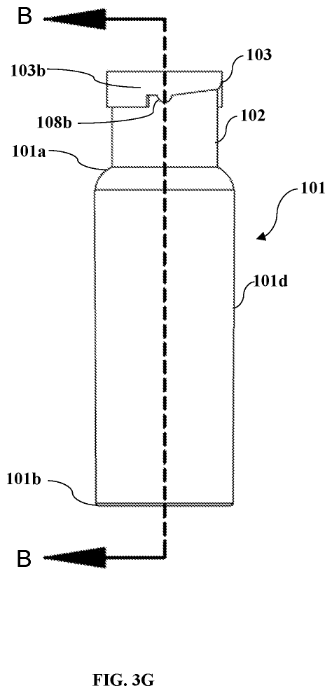

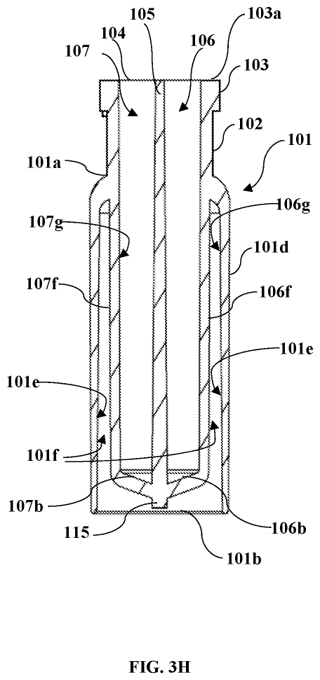

FIGS. 1A-1B illustrate an exploded, top perspective view and an exploded, bottom perspective view of an embodiment of a multi-volume vial apparatus 100, respectively. The multi-volume vial apparatus 100 illustrated in FIGS. 1A-1D is a dual-volume or dual-welled vial apparatus. The multi-volume vial apparatus 100 is used for containing multiple samples that need to be analyzed, for example, for organic volatile impurities, plastics, polymers, blood alcohol, flavors, etc., in an autosampler. In an exemplary application, the autosampler delivers the samples contained in the multi-volume vial apparatus 100 to an analytical instrument for analysis, for example, a high-pressure liquid chromatography (HPLC) analysis or a liquid chromatography-mass spectrometry (LC-MS) analysis. In the embodiment illustrated in FIGS. 1A-1D, the multi-volume vial apparatus 100 comprises a container 101, a septa member 109, and a closure 110. The container 101 defines an inner volume. The container 101 comprises a neck 102, a collar 103, at least one interior wall 105, and two or more first locking members 108a and 108b. The terms “first” and “second” are used herein for descriptive purposes only and are not to be construed to indicate or imply relative importance. The neck 102 extends from an upper end 101a of the container 101. The collar 103 comprises an opening 104 and is disposed on an upper end 102a of the neck 102. The interior wall 105 extends from a top end 103a of the collar 103 to a bottom end 101b of the container 101 as illustrated in FIG. 1C, FIG. 3D, and FIGS. 3H-3I. The interior wall 105 is configured to partition the inner volume into separate volumes defining separate wells 106 and 107 as illustrated in FIG. 1C and FIGS. 3H-3I, for containing samples. The opening 104 of the collar 103 is partitioned by a top end 105a of the interior wall 105 to provide separate access to the separate wells 106 and 107 as illustrated in FIG. 1A and FIG. 1C. Two first locking members 108a and 108b illustrated in FIGS. 1A-1B, FIG. 1D, FIG. 3B, FIG. 3G, FIG. 12A, FIGS. 13A-13B, FIGS. 14A-14B, and FIGS. 14D-14E, are configured diametrically on a circumferential wall 103b of the collar 103 of the container 101. In an embodiment, the multi-volume vial apparatus 100 comprises more than two first locking members 108a and 108b. In an embodiment, the first locking members 108a and 108b on the collar 103 of the container 101 are quarter-turn (¼-turn) locks with a maximum turn stop position. As used herein, “maximum turn stop position” refers to a position of the closure 110, when the closure 110 rotates about 90 degrees, that is, a quarter of a full circle, to engage second locking members, for example, quarter-turn locking lugs 113a and 113b configured on the closure 110 with the quarter-turn locks 108a and 108b configured on the collar 103 of the container 101, respectively, to securely lock the closure 110 to the collar 103 of the container 101. The first locking members 108a and 108b are herein exemplarily referred to as “quarter-turn locks”, and the second locking members 113a and 113b are herein exemplarily referred to as “quarter-turn locking lugs”. In the maximum turn stop position, the closure 110 completes the 90-degree rotation to come to a complete stop. The closure 110 is configured to rotate about 90 degrees to transition from a locked state to an unlocked state. In an embodiment, this maximum turn stop position is configured to align with specific markers, indicators, or mechanisms (not shown) to indicate the locked state or the unlocked state of the closure 110. In an embodiment, the quarter-turn locks 108a and 108b are equally-spaced from each other or disposed, for example, about 180 degrees, apart from each other around the collar 103 of the container 101.

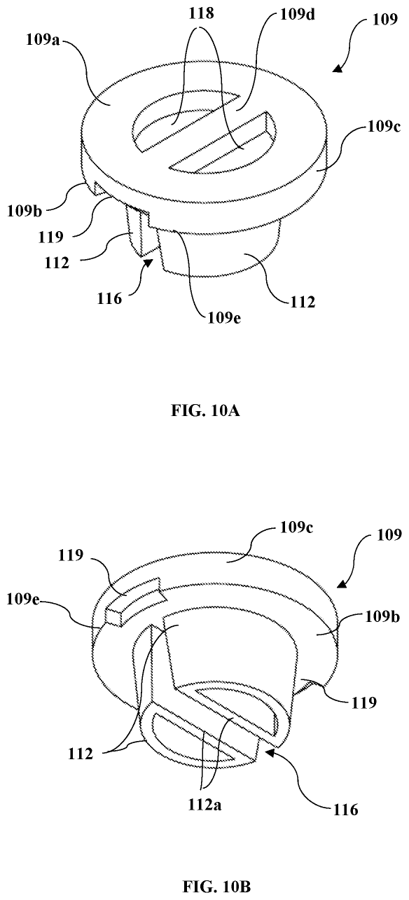

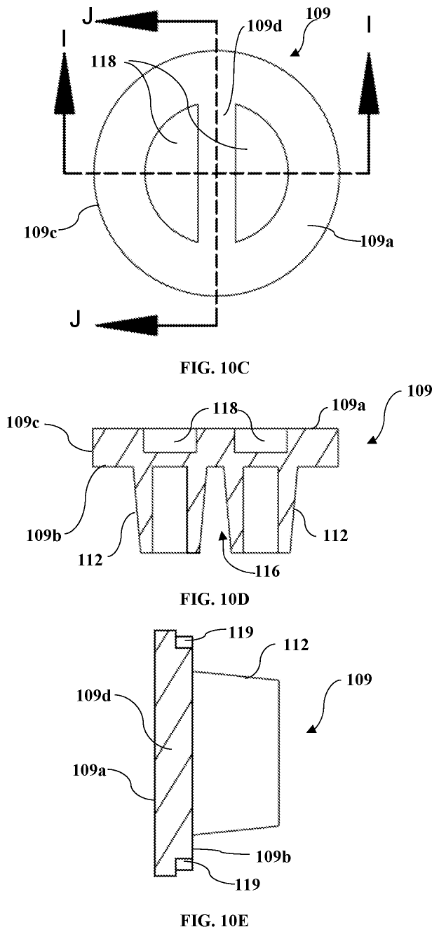

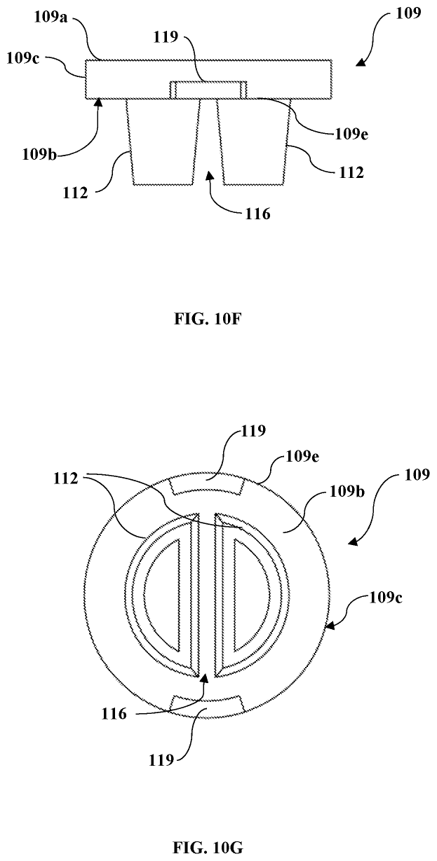

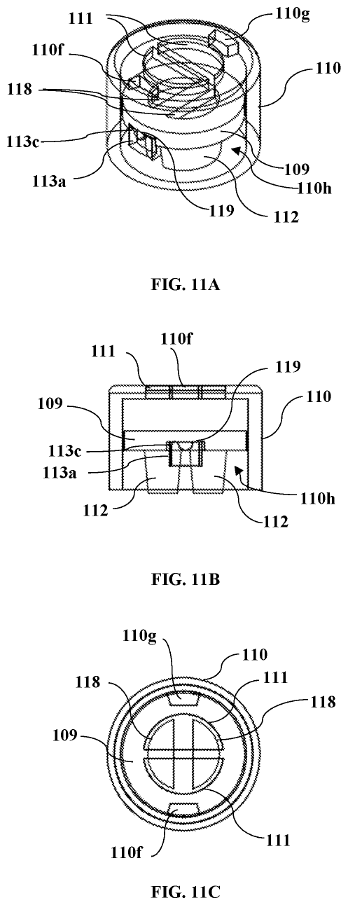

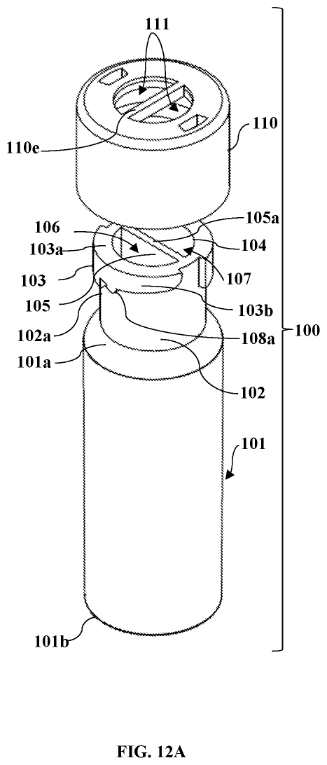

The septa member 109 is configured to be enclosed within an inner cavity 110h of the closure 110 and disposed on the top end 103a of the collar 103 of the container 101 to seal and maintain separation of the separate wells 106 and 107 of the container 101. Prior to disposing the septa member 109 on the top end 103a of the collar 103 of the container 101, the septa member 109 is first enclosed within the inner cavity 110h of the closure 110, and thereafter disposed on the collar 103 of the container 101 along with the closure 110 as disclosed in the descriptions of FIGS. 11A-11C, FIGS. 12A-12H, and FIGS. 13A-13D. In an embodiment as illustrated in FIG. 1B, FIG. 10B, and FIG. 10F, the septa member 109 comprises at least two opposing protruding sections 112 extending downwardly from a lower surface 109b of the septa member 109. The opposing protruding sections 112 of the septa member 109 are configured to fit securely within the partitioned opening 104 of the collar 103 of the container 101, illustrated in FIG. 1A, FIG. 3A, and FIGS. 3H-3I. The opposing protruding sections 112 define a groove 116 therebetween as illustrated in FIG. 3I, FIGS. 10A-10B, FIG. 10D, and FIGS. 10F-10G. The groove 116 between the opposing protruding sections 112 of the septa member 109 is configured to mate with and firmly receive the top end 105a of the interior wall 105 of the container 101 as illustrated in FIG. 3I. In an embodiment, the opposing protruding sections 112 of the septa member 109 are tapered, as illustrated in FIG. 1C and FIGS. 10D-10F, to mate with inner walls 106g and 107g of the separate wells 106 and 107 of the container 101, respectively, as illustrated in FIGS. 3H-3I.

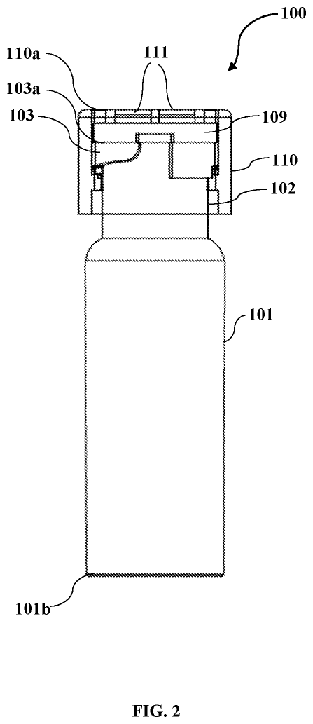

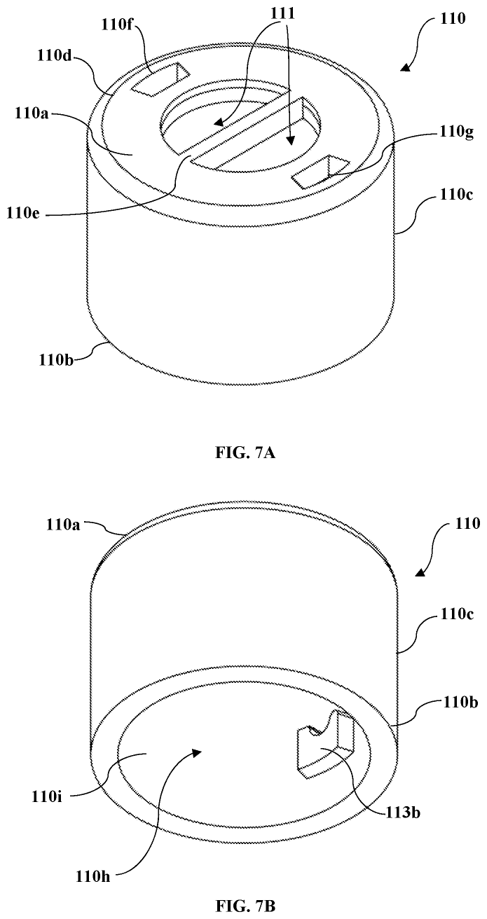

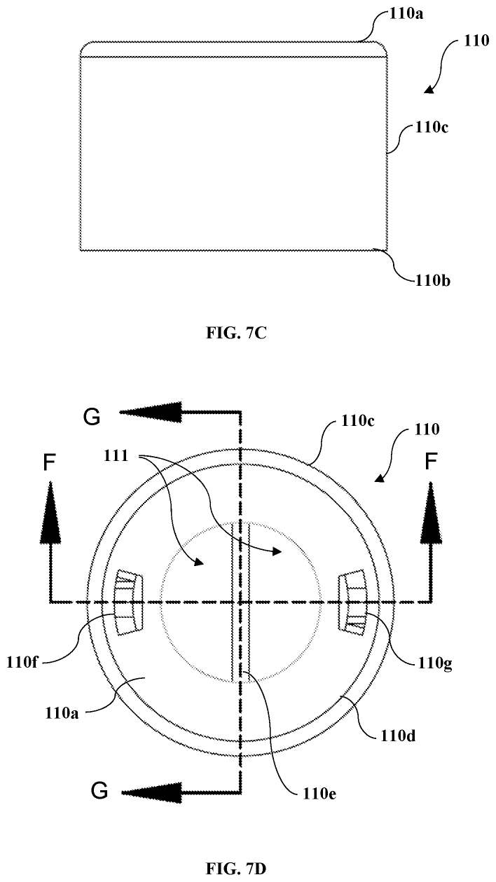

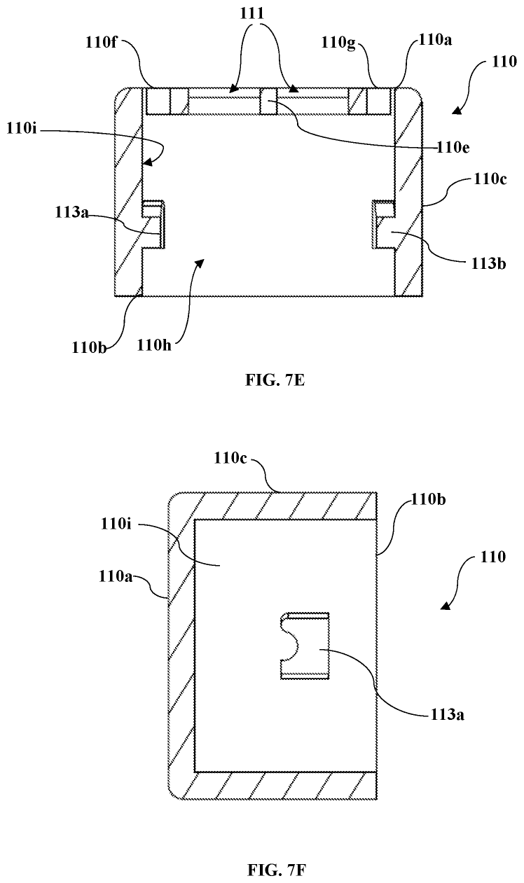

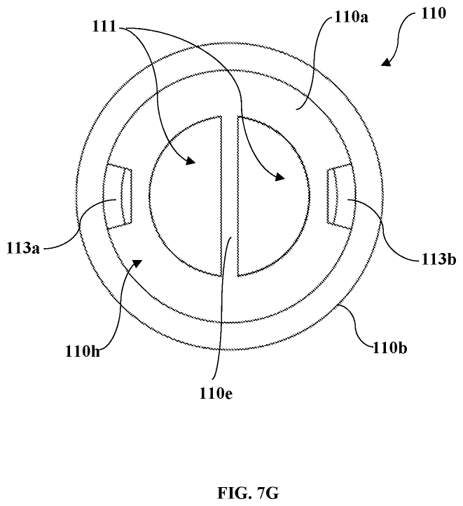

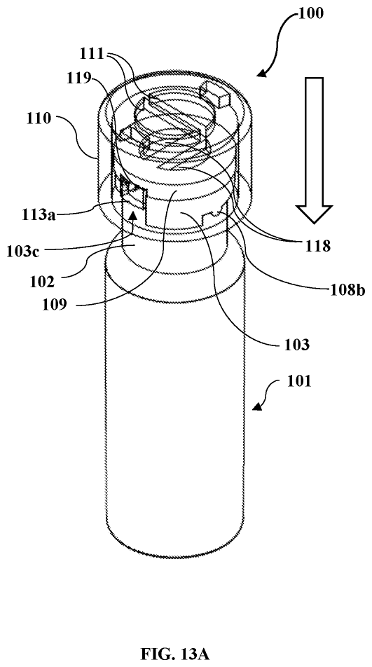

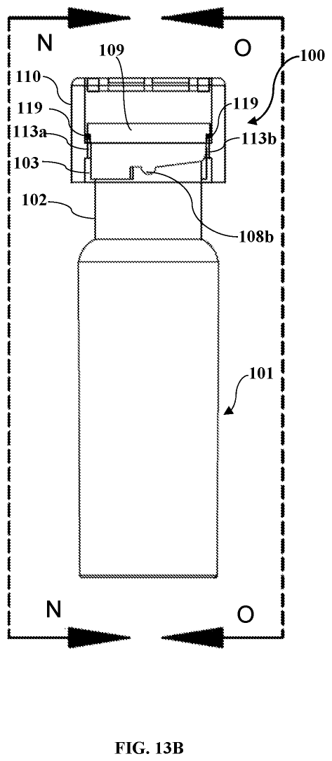

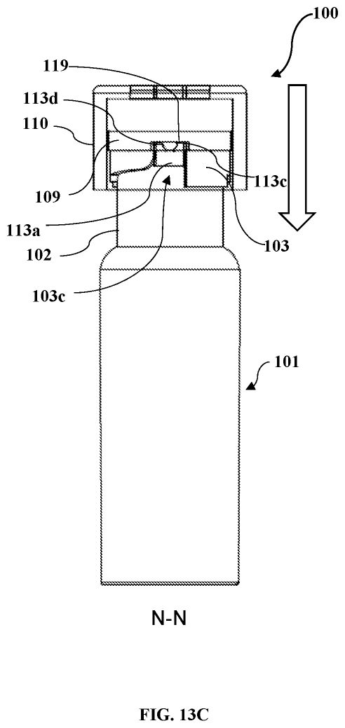

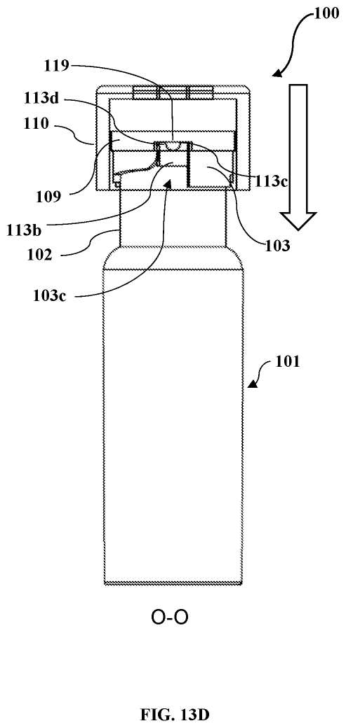

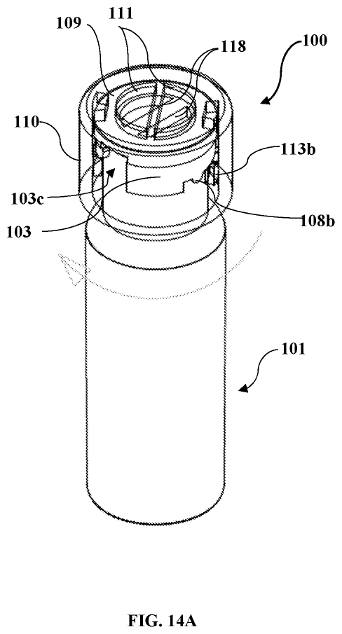

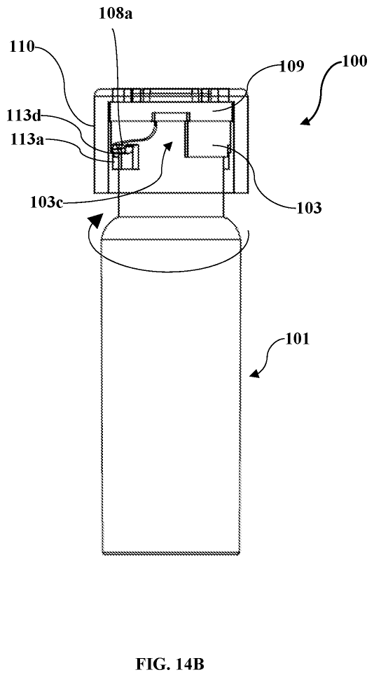

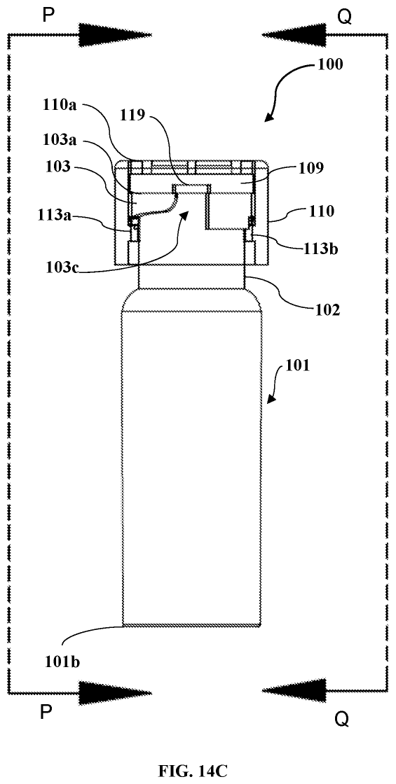

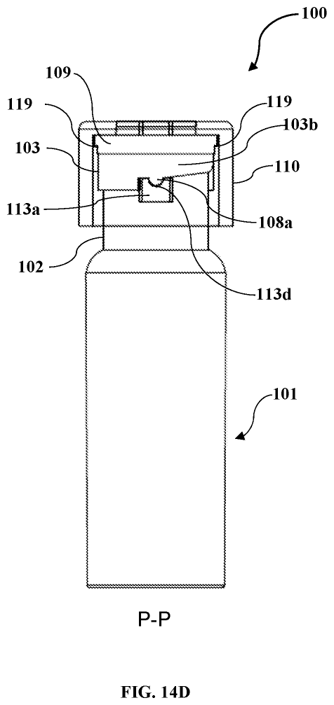

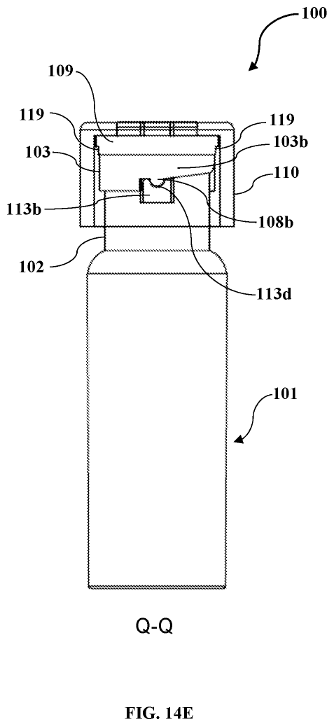

The closure 110 is configured to enclose the septa member 109 as illustrated in FIGS. 11A-11C, and cover the collar 103 of the container 101 as illustrated in FIG. 2, FIGS. 13A-13D, and FIGS. 14A-14E. FIGS. 1A-1B provide a transparent view of the closure 110 showing internal aspects of the closure 110. In an embodiment, the closure 110 comprises two second locking members 113a and 113b disposed diametrically on an inner surface 110i of the closure 110 as illustrated in FIGS. 1A-1B, FIG. 7B, and FIG. 7E. In an embodiment, the multi-volume vial apparatus 100 comprises more than two second locking members 113a and 113b. The second locking members 113a and 113b of the closure 110 are configured to engage with the first locking members 108a and 108b on the collar 103 of the container 101, respectively, to lock the container 101 as illustrated in FIGS. 14D-14E. In an embodiment, the second locking members 113a and 113b of the closure 110 are quarter-turn locking lugs configured to engage with the quarter-turn locks on the collar 103 of the container 101 and lock the container 101 by a quarter turn of the closure 110 on the collar 103 of the container 101, without displacing the septa member 109 on the collar 103 of the container 101. For purposes of illustration, the disclosure herein refers to the first locking member and the second locking member being a quarter-turn lock 108a or 108b and a quarter-turn locking lug 113a or 113b, respectively; however, the scope of the multi-volume vial apparatus 100 disclosed herein is not limited to the locking members being a quarter-turn lock 108a or 108b and a quarter-turn locking lug 113a or 113b, but extends to include any mating structures, connectors, couplers, etc., that allow locking or unlocking of the closure 110 to the container 101 by a quarter-turn or any other functionally equivalent locking mechanism.

In an embodiment, the closure 110 further comprises at least two openings 111 configured to match the partitioned opening 104 of the collar 103 of the container 101. The openings 111 of the closure 110 are oriented to align with the partitioned opening 104 of the collar 103 of the container 101 and in turn, with the separate wells 106 and 107 of the container 101, in a locked condition of the container 101. As used herein, “locked condition” of the container 101 refers to a condition where the closure 110 with the enclosed septa member 109 is rotated by 90 degrees or quarter-turned on the collar 103 of the container 101 such that the second locking members 113a and 113b of the closure 110 engage with the first locking members 108a and 108b on the collar 103 of the container 101, respectively, to lock the container 101. The closure 110 is configured to allow the opposing protruding sections 112 of the enclosed septa member 109 to be oriented to seal the separate wells 106 and 107 of the container 101 individually. The closure 110 is further configured to rotate and lock the septa member 109 in position on the collar 103 of the container 101 by engagement of the second locking members 113a and 113b of the closure 110 with the first locking members 108a and 108b on the collar 103 of the container 101, respectively.

The closure 110 is further configured to perform a maximum turn stop without over-torquing and displacing the septa member 109 while providing a uniform seal, preventing leakage of the samples contained in the separate wells 106 and 107 of the container 101, and providing a visual indication of locations of the separate wells 106 and 107 in the container 101. As used herein, “maximum turn stop” refers to a mechanical limit that prevents the closure 110 from being turned beyond a certain point in its rotational movement. The maximum turn stop is the furthest point to which the closure 110 can be rotated in one direction before the quarter-turn locking lug 113a or 113b reaches its maximum allowable position, that is, the position of the quarter-turn lock 108a or 108b on the collar 103 of the container 101. The maximum turn stop ensures that the quarter-turn locking lug 113a or 113b of the closure 110 cannot be turned past the maximum allowable position, thereby preventing over-rotation and potential damage to the closure 110 and/or the collar 103 of the container 101 and preserving the orientation and alignment of the openings 111 of the closure 110 with the separate wells 106 and 107 in the container 101. Furthermore, the maximum turn stop precludes misorientation of the openings 111 of the closure 110 with respect to the separate wells 106 and 107 in the container 101.

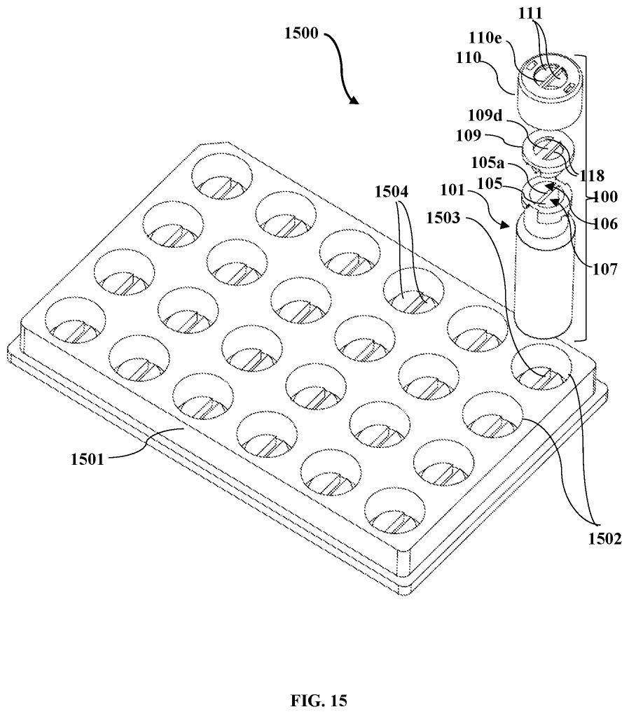

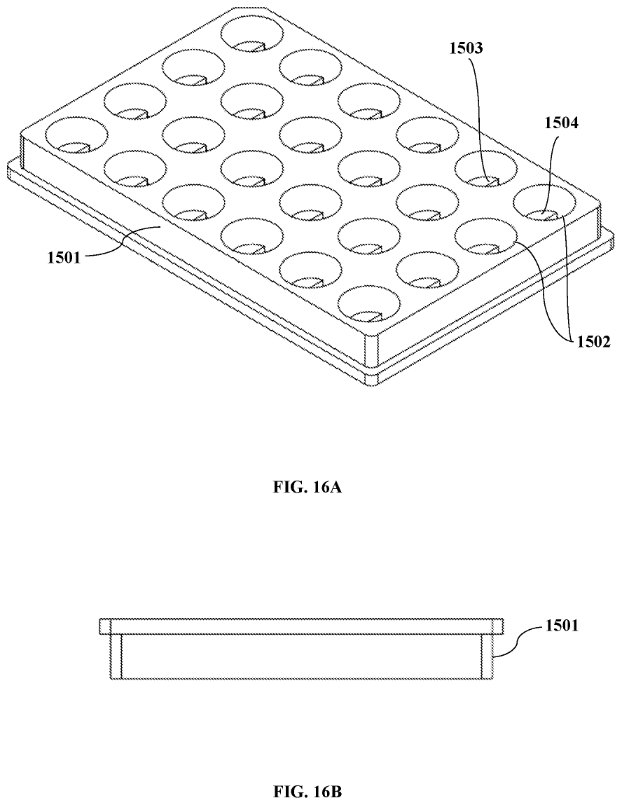

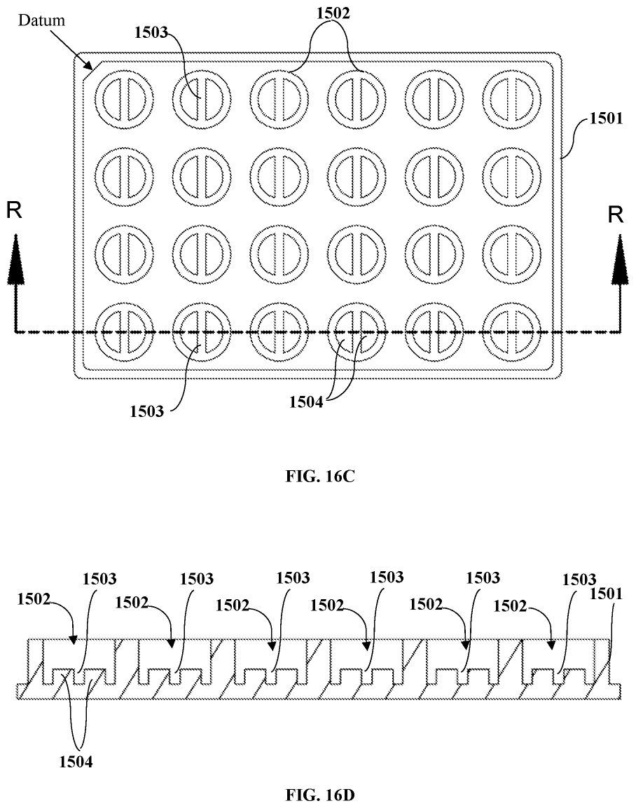

In an embodiment, the multi-volume vial apparatus 100 further comprises one or more protruding elements 115 attached to the bottom end 101b of the container 101. For example, the multi-volume vial apparatus 100 comprises one protruding element 115 configured as a blade attached to the bottom end 101b of the container 101 as illustrated in FIG. 1B. In an embodiment, the protruding element 115 is configured as a mechanical lug. The protruding element 115 is configured to engage with a mating notch 1503 of a receptacle 1502 disposed in a plate member 1501 of automated laboratory equipment as illustrated in FIG. 15 and FIGS. 16A-16D, for positioning, holding, and securing the container 101 of the multi-volume vial apparatus 100 in position within the receptacle 1502 to preclude rotation of the container 101 during different operations performed on the container 101. The protruding element 115 is further configured to indicate locations of the separate wells 106 and 107 partitioned by the interior wall 105 of the container 101. In an embodiment as illustrated in FIG. 1B, the bottom end 101b of the container 101 comprises a cavity 114 for housing the protruding element 115 in the container 101. The cavity 114 extends from an inward base 101c outwardly towards the bottom end 101b of the container 101 as illustrated in FIG. 1B and FIG. 3B. In an embodiment, the protruding element 115 is molded as a ridge-like piece to the inward base 101c of the container 101. In an embodiment, the multi-volume vial apparatus 100 is configured to be used free of the septa member 109 and the closure 110.

FIG. 1C illustrates an exploded, front elevation view of the embodiment of the multi-volume vial apparatus 100 shown in FIG. 1A. The exploded, front elevation view in FIG. 1C illustrates the quarter-turn locking lugs 113a and 113b of the closure 110, the opposing protruding sections 112 of the septa member 109, and the separate wells 106 and 107 created by the interior wall 105 in the container 101. In an example, the upper width of each of the groove 116 of the septa member 109 and the top end 105a of the interior wall 105 that allows the groove 116 to receive the top end 105a of the interior wall 105 of the container 101 is about 0.035 inches, and the lower width of the groove 116 is about 0.066 inches.

FIG. 1D illustrates an exploded, right-side elevation view of the embodiment of the multi-volume vial apparatus 100 shown in FIG. 1A. The exploded, right-side elevation view in FIG. 1D illustrates the right-side quarter-turn locking lug 113b of the closure 110, one of the opposing protruding sections 112 of the septa member 109, the right-side well 107 in the container 101, and the quarter-turn lock 108b configured on the circumferential wall 103b of the collar 103 of the container 101. In an example, the thickness of the circumferential wall 103b of the collar 103 of the container 101 is about 0.03 inches.

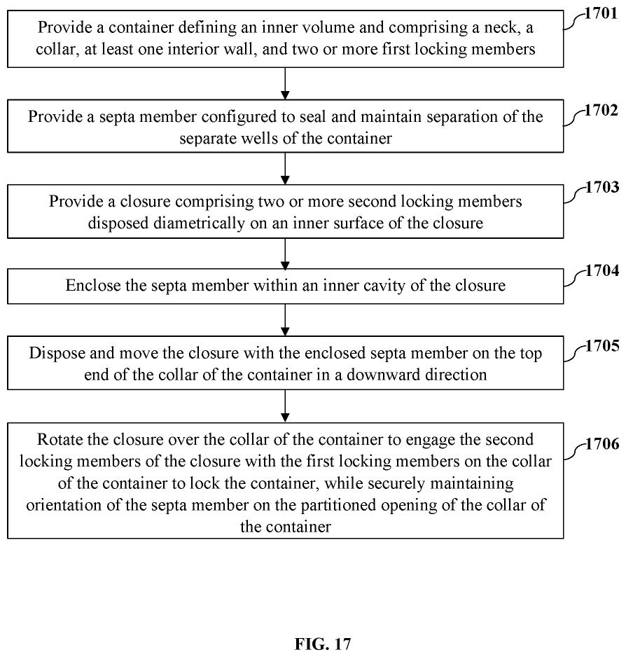

FIG. 2 illustrates an assembled, front elevation view of the embodiment of the multi-volume vial apparatus 100 shown in FIG. 1A. The multi-volume vial apparatus 100 is assembled by first enclosing the septa member 109 within the inner cavity 110h of the closure 110 and thereafter disposing the closure 110 with the enclosed septa member 109 on the top end 103a of the collar 103 of the container 101 and covering the collar 103 of the container 101 as disclosed in the description of FIG. 17. In an example, the height of the multi-volume vial apparatus 100 from the upper end 110a of the closure 110 to the bottom end 101b of the container 101 is from about 1.93 inches to about 1.945 inches, and the diameter of the container 101 is about 0.58 inches. In an embodiment, the multi-volume vial apparatus 100 provides areas for printing identification information, barcodes, and other indicators. The container 101, the septa member 109, and the closure 110 of the multi-volume vial apparatus 100 are manufactured using different methods comprising, for example, three-dimensional (3D) prototype printing, injection compression molding, etc.

FIGS. 3A-3B illustrate a top perspective view and a bottom perspective view of an embodiment of the container 101 of the multi-volume vial apparatus 100 shown in FIG. 1A, respectively. In an embodiment, the container 101 is a generally cylindrical member comprising a curved lateral wall or a circumferential wall 101d between the upper end 101a and the bottom end 101b of the container 101. The upper end 101a of the container 101 curvedly extends to meet a lower end 102b of the neck 102. In an embodiment, the neck 102 of the container 101 is of a generally cylindrical shape. The collar 103 is disposed on the upper end 102a of the neck 102. In addition to the quarter-turn locks 108a and 108b configured on the circumferential wall 103b of the collar 103 as illustrated in FIGS. 3A-3B, FIG. 3G, FIG. 12A, FIG. 12F, and FIGS. 14D-14E, the collar 103 comprises notches 103c configured on the circumferential wall 103b of the collar 103 and diametrically disposed on opposing sides 105b and 105c of the interior wall 105 as illustrated in FIG. 3A. In an example, the width of each of the notches 103c is about 0.138 inches. The notches 103c on the collar 103 of the container 101 are configured to receive and seat the quarter-turn locking lugs 113a and 113b of the closure 110 in an unlocked condition of the container 101 as illustrated in FIGS. 13A-13D. As used herein, “unlocked condition” of the container 101 refers to a condition where the closure 110 with the enclosed septa member 109 is disposed on the collar 103 of the container 101 such that the notches 103c on the collar 103 of the container 101 receive and seat the quarter-turn locking lugs 113a and 113b of the closure 110 as illustrated in FIGS. 13A-13D, prior to rotation of the closure 110, for example, by a quarter-turn or by 90 degrees, to lock the container 101. In the unlocked condition of the container 101, the openings 111 of the closure 110 are oriented about 90 degrees with respect to recesses 118 of the septa member 109 as illustrated in FIGS. 11A-11C, FIG. 12F, FIG. 13A, and FIG. 14A.

The opening 104 of the collar 103 of the container 101 is partitioned based on the number of separate volumes defining separate wells in the container 101. For example, for a dual-volume vial apparatus 100 illustrated in FIGS. 1A-1D, the opening 104 of the collar 103 of the container 101 is partitioned by one interior wall 105 to create two separate volumes defining two separate wells 106 and 107 in the container 101. In another example, for a triple-volume vial apparatus (not shown), the opening 104 of the collar 103 of the container 101 is partitioned by two or three interior walls 105 to create three separate volumes defining three separate wells in the container 101. In another example, for a quadruple-volume vial apparatus (not shown), the opening 104 of the collar 103 of the container 101 is partitioned by two, three, or four interior walls 105 to create four separate volumes defining four separate wells in the container 101.

The bottom perspective view in FIG. 3B illustrates the blade-like protruding element 115 attached to and extending downwardly from the base 101c of the container 101 within the cavity 114 defined at the bottom end 101b of the container 101. The protruding element 115 is a securing mechanism for securely positioning and holding the container 101 of the multi-volume vial apparatus 100 within the receptacle 1502 of the plate member 1501 of an automated laboratory assembly 1500 illustrated in FIG. 15 and FIGS. 16A-16D, when different operations, for example, placing the closure 110 on the container 101, removing the closure 110 from the container 101, labeling the container 101, etc., are performed on the container 101. The protruding element 115 indicates the location and the orientation of the interior wall 105, and in turn, the separate wells 106 and 107 of the container 101, thereby presenting the separate volumes of the container 101 for convenient access by automated laboratory equipment probes, for example, during a sampling process, and allowing the throughput of the sampling process to be increased. The protruding element 115, when engaged with the mating notch 1503 of the receptacle 1502 of the plate member 1501, secures the container 101 within the receptacle 1502, thereby precluding the container 101 from turning when different operations are performed on the container 101. In an embodiment, the container 101 and the blade-like protruding element 115 are constructed from a polymeric material as a single piece during injection molding. In an example, the thickness of the blade-like protruding element 115 is about 0.08 inches. In an example, the height and the diameter of the neck 102 of the container 101 are about 0.4 inches and 0.44 inches, respectively; the diameter and the height of the collar 103 of the container 101 are about 0.481 inches and 0.15 inches, respectively; the height of the container 101 is about 1.810 inches; and the diameter of the bottom end 101b of the container 101 is about 0.582 inches.

FIG. 3C illustrates a front elevation view of the embodiment of the container 101 shown in FIG. 3A. The front elevation view in FIG. 3C illustrates one of the notches 103c of the collar 103 of the container 101. FIG. 3D illustrates a cross-sectional view of the embodiment of the container 101 shown in FIG. 3A, taken along a sectional line A-A shown in FIG. 3C. The cross-sectional view in FIG. 3D illustrates the interior wall 105 configured to partition the inner volume of the container 101. The inner volume of the container 101 comprises a space 101f defined between an inner wall 101e of the container 101 and outer walls 106f and 107f of the separate wells 106 and 107, respectively, as illustrated in FIGS. 3H-3I. The space 101f between the inner wall 101e of the container 101 and the outer walls 106f and 107f of the separate wells 106 and 107, respectively, is created during an injection molding process to reduce the thickness of the circumferential wall 101d of the container 101. A thin circumferential wall 101d allows for convenient handling of the container 101 for performing multiple operations on the multi-volume vial apparatus 100 illustrated in FIGS. 1A-1D and FIG. 2. In an embodiment, the circumferential wall 101d of the container 101 and the outer walls 106f and 107f of the separate wells 106 and 107, respectively, are produced, for example, by mold steel, to reduce their thickness to preclude deformation of the walls 101d, 106f, and 107f of the container 101 as a polymer material transitions from a liquid state to a solid state during the injection molding process. In an example, steel cores and cavities are used to form the walls 101d, 106f, and 107f of the container 101 with a reduced thickness during the injection molding process. The walls 101d, 106f, and 107f of the container 101 with a reduced thickness further reduce the weight of the multi-volume vial apparatus 100 due to reduced usage of the polymer material, thereby reducing environmental impact, space requirements, manufacturing costs, shipping costs, etc. In an embodiment, the walls 101d, 106f, and 107f of the container 101 with a reduced thickness improve visibility of the samples contained therein, thereby improving monitoring and analysis of the samples and visual inspections. The thin-walled multi-volume vial apparatus 100 is more compatible with automated laboratory equipment due to their lighter weight and flexibility.

FIG. 3E illustrates a top plan view of the embodiment of the container 101 shown in FIG. 3A. The top plan view in FIG. 3E illustrates the opening 104 of the collar 103 partitioned by the top end 105a of the interior wall 105 of the container 101. The top end 105a of the interior wall 105 of the container 101 partitions the opening 104 of the collar 103 into two opposing D-shaped sections that define the upper ends 106a and 107a of the separate wells 106 and 107, respectively, as illustrated in FIG. 3E. In an example, the diameter of each of the two opposing D-shaped sections that define the upper ends 106a and 107a of the separate wells 106 and 107, respectively, is about 0.343 inches. The top plan view in FIG. 3E also illustrates the notches 103c configured on opposing sides 105b and 105c of the interior wall 105 of the container 101.

FIG. 3F illustrates a bottom elevation view of the embodiment of the container 101 shown in FIG. 3A. The bottom elevation view in FIG. 3F illustrates the protruding element 115 attached to the base 101c within the cavity 114 defined at the bottom end 101b of the container 101. In an embodiment, the protruding element 115 is configured as an anti-rotation lug that precludes rotation of the container 101 and allows loading and orientation in an automated laboratory assembly 1500 as illustrated in FIG. 15. In an example, a probe head of an autosampler is disposed at a fixed position to enter the container 101 illustrated in FIG. 3A, FIG. 3E, and FIGS. 3H-3I. The protruding element 115 attached to the base 101c within the cavity 114 of the container 101, when disposed in the receptacle 1502 of the plate member 1501 of the automated laboratory assembly 1500 illustrated in FIG. 15, allows the separate wells 106 and 107 of the container 101 to be oriented and presented in an accurate position to accept the probe head of the autosampler. The orientation function provided by the protruding element 115 ensures the container 101 is in a proper position in the automated laboratory assembly 1500 to accept the fixed position probe head of the autosampler. The protruding element 115 secures the container 101 within the receptacle 1502 of the plate member 1501, for example, when an automatic capping mechanism applies a downward force while rotating the closure 110 for placement and/or removal of the closure 110 on/from the container 101 illustrated in FIG. 2.

FIG. 3G illustrates a right-side elevation view of the embodiment of the container 101 shown in FIG. 3A. The right-side elevation view in FIG. 3G illustrates the quarter-turn lock 108b configured on the circumferential wall 103b of the collar 103 of the container 101.

FIGS. 3H-3I illustrate a cross-sectional, elevation view and a cross-sectional, perspective view of the embodiment of the container 101 shown in FIG. 3A, respectively, taken along a sectional line B-B shown in FIG. 3G. FIG. 3I also illustrates a cross-sectional, perspective view of the closure 110 with the enclosed septa member 109 disposed on the collar 103 of the container 101. The cross-sectional views in FIGS. 3H-3I illustrate the interior wall 105 that partitions the inner volume of the container 101 into separate volumes defining the separate wells 106 and 107 of the container 101. The volume of each of the wells 106 and 107 of the container 101 with bottom ends 106b and 107b, respectively, illustrated in FIGS. 3H-3I, is, for example, about 1 milliliter (ml). The space 101f defined by the inner volume of the container 101 is configured to accommodate the separate wells 106 and 107 of different shapes within the container 101. The outer walls 106f and 107f of the separate wells 106 and 107, respectively, extend internally in a downward direction from the partitioned opening 104 of the container 101 towards the bottom end 101b of the container 101 as illustrated in FIG. 3H.

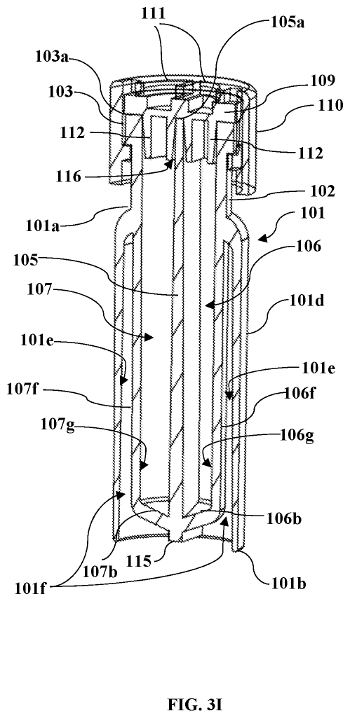

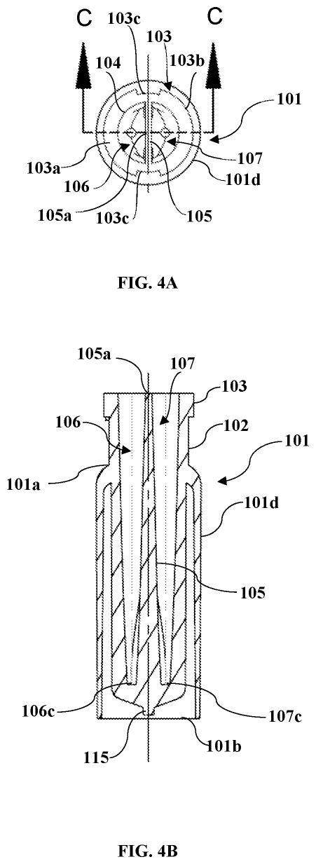

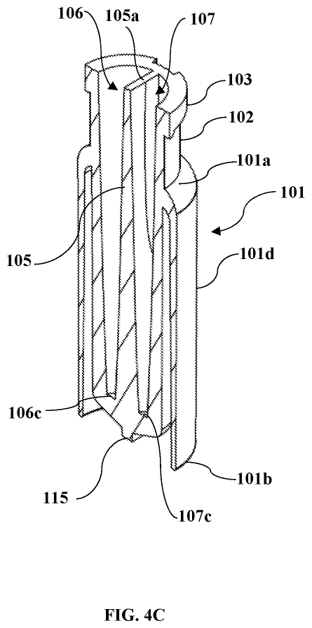

In an embodiment, the bottom ends 106b and 107b of the separate wells 106 and 107 of the container 101, respectively, are configured in one or more of multiple shapes, for example, flat shapes, conical shapes, rounded shapes, pointed shapes, etc., for substantial recovery of the samples contained therein as disclosed in the descriptions of FIGS. 4A-4C, FIGS. 5A-5C, and FIGS. 6A-6C. Alternative configurations of the separate wells 106 and 107 of the container 101 are illustrated in FIGS. 4A-4C, FIGS. 5A-5C, and FIGS. 6A-6C. These configurations of the separate wells 106 and 107 of the container 101 allow for reduced volumes, full extraction, acceptance of glass inserts, or any combination thereof. The shapes of the bottom ends 106b and 107b of the separate wells 106 and 107 of the container 101, respectively, are configured to optimize the recovery or retrieval of the samples, for example, liquid samples, contained in the container 101 of the multi-volume vial apparatus 100, thereby minimizing any residue left behind. The shapes of the bottom ends 106b and 107b of the separate wells 106 and 107, respectively, are optimized to facilitate complete dispensing or withdrawal of the samples from the multi-volume vial apparatus 100, ensuring optimized use and reducing waste, for example, in autosampling and other laboratory procedures and applications that require accurate dosing or sample recovery such as in pharmaceuticals, biotechnology, and analytical chemistry. The cross-sectional views in FIGS. 3H-3I also illustrate the blade-like protruding element 115 disposed at the bottom end 101b of the container 101. In an embodiment, the container 101 with its neck 102 and its collar 103 is made from a polymeric material selected, for example, from polypropylene, polyethylene, polystyrene, polycarbonate, cyclic olefin copolymer (COC), etc.

FIG. 4A illustrates a top plan view of another embodiment of the container 101 of the multi-volume vial apparatus 100. In an embodiment, the separate wells 106 and 107 of the container 101 are tapered to reduce their separate volumes. In another embodiment, the volume of each of the separate wells 106 and 107 are further tapered to reduce their volume. In another embodiment, the separate wells 106 and 107 of the container 101 are configured to receive glass inserts.

FIGS. 4B-4C illustrate a cross-sectional, elevation view and a cross-sectional, perspective view of the embodiment of the container 101 shown in FIG. 4A, respectively, taken along a sectional line C-C shown in FIG. 4A. The cross-sectional views in FIGS. 4B-4C illustrate the reduced or limited volumes created by the tapered separate wells 106 and 107 of the container 101. In an embodiment, the bottom ends 106c and 107c of the separate wells 106 and 107 of the container 101, respectively, are conical ends as illustrated in FIGS. 4A-4C, for insertion of glass inserts and substantial recovery of the samples contained in the separate wells 106 and 107. The conical bottom ends 106c and 107c of the separate wells 106 and 107 of the container 101 allow insertion of limited volume inserts during a sample analysis to reduce usage and wastage of solvents and to optimally recover small samples contained within the separate wells 106 and 107 of the container 101. Limited volume inserts are used for improving injection accuracy and minimizing sample loss.

In an example, during a centrifugation process, particles or sediment settle towards the tips of the conical bottom ends 106c and 107c of the separate wells 106 and 107 of the container 101, respectively. This concentration of the particles at the tips of the conical bottom ends 106c and 107c of the separate wells 106 and 107, respectively, allow convenient extraction of the supernatant or the liquid portion of the respective samples without disturbing the particles, resulting in optimal sample recovery. Moreover, the conical bottom ends 106c and 107c of the separate wells 106 and 107, respectively, promote complete drainage of the samples from the separate wells 106 and 107, minimizing residual sample volume, thereby ensuring that the samples are substantially recovered, reducing waste and maximizing the yield of usable materials in the samples. Compared to flat bottom ends, the conical bottom ends 106c and 107c of the separate wells 106 and 107 typically have a smaller dead volume, thereby leaving less space where the samples cannot be optimally accessed or recovered, which reduces the loss of sample volume and improves recovery efficiency. In another example, during a pipetting process, the conical bottom ends 106c and 107c of the separate wells 106 and 107, respectively, provide narrower openings, allowing pipette tips to reach closer to the bottom ends 106c and 107c of the separate wells 106 and 107, thereby facilitating the aspiration of small volume samples, ensuring optimal recovery. Furthermore, the conical bottom ends 106c and 107c of the separate wells 106 and 107, respectively, reduce the risk of cross-contamination between samples by concentrating any residual liquid or particles towards the tip of the conical bottom ends 106c and 107c of the separate wells 106 and 107, respectively, thereby minimizing the likelihood of contamination when transferring samples between vials or during storage. The separate wells 106 and 107 with the conical bottom ends 106c and 107c, respectively, are therefore optimally-suited for a wide range of laboratory applications comprising, for example, sample preparation, storage, and analysis.

In an example, the height of each of the wells 106 and 107 of the container 101 illustrated in FIGS. 4B-4C is about 1.62 inches, and the diameter of each of the conical bottom ends 106c and 107c of the separate wells 106 and 107, respectively, illustrated in FIG. 4A is about 0.05 inches. The volume of each of the wells 106 and 107 illustrated in FIGS. 4B-4C is, for example, about 0.5 milliliters (ml).

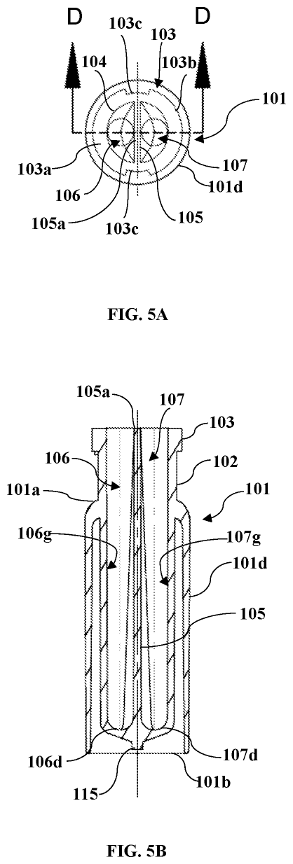

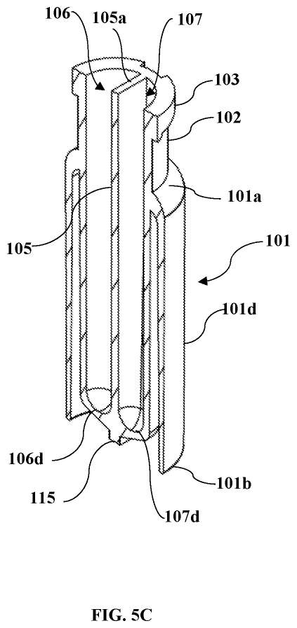

FIG. 5A illustrates a top plan view of another embodiment of the container 101 of the multi-volume vial apparatus 100. FIGS. 5B-5C illustrate a cross-sectional, elevation view and a cross-sectional, perspective view of the embodiment of the container 101 shown in FIG. 5A, respectively, taken along a sectional line D-D shown in FIG. 5A. In an embodiment, the bottom ends 106d and 107d of the separate wells 106 and 107 of the container 101, respectively, are rounded ends as illustrated in FIGS. 5A-5C, for substantial recovery of the samples. The rounded bottom ends 106d and 107d of the separate wells 106 and 107, respectively, allow optimal vortexing and reduce liquid retention on the walls 106g and 107g of the separate wells 106 and 107, respectively, during sample recovery. In an example, the height of each of the wells 106 and 107 of the container 101 illustrated in FIGS. 5B-5C is about 1.68 inches, and the radius of each of the rounded bottom ends 106d and 107d of the separate wells 106 and 107, respectively, illustrated in FIG. 5A, is about 0.07 inches. The volume of each of the wells 106 and 107 illustrated in FIGS. 5B-5C is, for example, about 0.75 milliliters (ml).

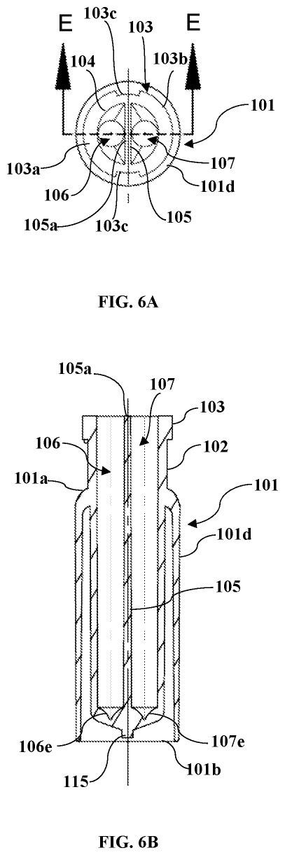

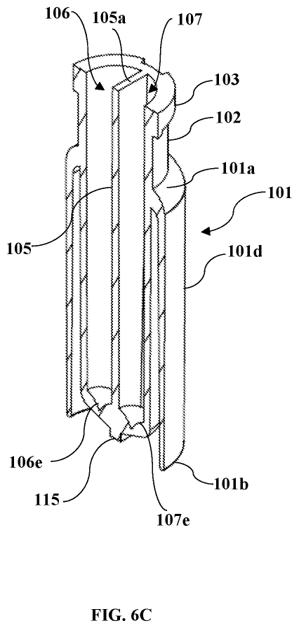

FIG. 6A illustrates a top plan view of another embodiment of the container 101 of the multi-volume vial apparatus 100. FIGS. 6B-6C illustrate a cross-sectional, elevation view and a cross-sectional, perspective view of the embodiment of the container 101 shown in FIG. 6A, respectively, taken along a sectional line E-E shown in FIG. 6A. In an embodiment, the bottom ends 106e and 107e of the separate wells 106 and 107 of the container 101, respectively, are pointed ends as illustrated in FIGS. 6A-6C, for full extraction and recovery of the samples. The pointed bottom ends 106e and 107e of the separate wells 106 and 107, respectively, concentrate solvents and small samples, thereby allowing substantial and optimal sample recovery with a needle or a pipette as disclosed in the description of FIGS. 4A-4C. In an example, the height of each of the wells 106 and 107 of the container 101 illustrated in FIGS. 6B-6C is about 1.69 inches, and the diameter of each of the bottom ends 106e and 107e of the separate wells 106 and 107, respectively, illustrated in FIG. 6A, is about 0.145 inches. The volume of each of the wells 106 and 107 illustrated in FIGS. 6B-6C is, for example, about 0.75 milliliters (ml).

FIGS. 7A-7B illustrate a top perspective view and a bottom perspective view of an embodiment of the closure 110 of the multi-volume vial apparatus 100 shown in FIG. 1A, respectively. In an embodiment, the closure 110 comprises a generally cylindrical wall 110c defined between an upper end 110a and a lower end 110b of the closure 110. The generally cylindrical wall 110c of the closure 110 extends downwardly from the upper end 110a of the closure 110. In an embodiment, the upper end 110a and the bottom end 110b of the closure 110 are generally flat as illustrated in FIGS. 7A-7B. The top perspective view in FIG. 7A illustrates the two openings 111 configured on the upper end 110a of the closure 110 to match the partitioned opening 104 of the collar 103 of the container 101 illustrated in FIG. 1A. In an embodiment as illustrated in FIG. 7A, the two openings 111 are configured as opposing D-shaped sections configured to match the opposing D-shaped sections of the partitioned opening 104 of the collar 103. The openings 111 are separated by a partitioning element 110e configured to match the top end 105a of the interior wall 105 of the container 101 in the locked condition of the container 101. In an example, the width of the partitioning element 110e of the closure 110 is about 0.035 inches, and the diameter of each of the openings 111 of the closure 110 is from about 0.333 inches to about 0.334 inches.

The number of openings 111 of the closure 110 is configured to be equal to the number of separate volumes defining separate wells in the container 101. For example, for a dual-volume vial apparatus 100 illustrated in FIGS. 1A-1D, two openings 111 of the closure 110 correspond to two separate volumes defining two separate wells 106 and 107 in the container 101. In another example, for a triple-volume vial apparatus (not shown), three openings 111 of the closure 110 correspond to three separate volumes defining three separate wells in the container 101. In another example, for a quadruple-volume vial apparatus (not shown), four openings 111 of the closure 110 correspond to four separate volumes defining four separate wells in the container 101. The top perspective view in FIG. 7A also illustrates two notches 110f and 110g diametrically disposed proximal to a peripheral edge 110d of the upper end 110a of the closure 110. The notches 110f and 110g are configured to align with the quarter-turn locking lugs and 113a and 113b disposed on the inner surface 110i of the closure 110, respectively, as illustrated in FIG. 7E. In an example, during injection molding of the closure 110, the notches 110f and 110g are created by steel cores mating with a steel cavity side to create the quarter-turn locking lugs 113a and 113b. The bottom perspective view in FIG. 7B illustrates one of the quarter-turn locking lugs, that is, the quarter-turn locking lug 113b, disposed in the inner surface 110i of the closure 110. Furthermore, the upper end 110a and the generally cylindrical wall 110c of the closure 110 define the inner cavity 110h as illustrated in FIG. 7B, for receiving the septa member 109 and the collar 103 of the container 101, when the closure 110 closes the container 101 as illustrated in FIG. 2, FIGS. 13A-13D, and FIGS. 14A-14E.

FIG. 7C illustrates a front elevation view of the embodiment of the closure 110 shown in FIG. 7A, the rear elevation view, the right-side elevation view, and the left-side elevation view being mirror images thereof. In an example, the height of the closure 110 is about 0.435 inches; the inner diameter of the closure 110 is about 0.527 inches; and the outer diameter of the closure 110 is about 0.64 inches. In an embodiment, the closure 110 is made from a polymeric material selected, for example, from polypropylene, polyethylene, polycarbonate, ethylene vinyl acetate (EVA), polyoxymethylene (POM) also referred to as acetal, an acetal copolymer, etc.

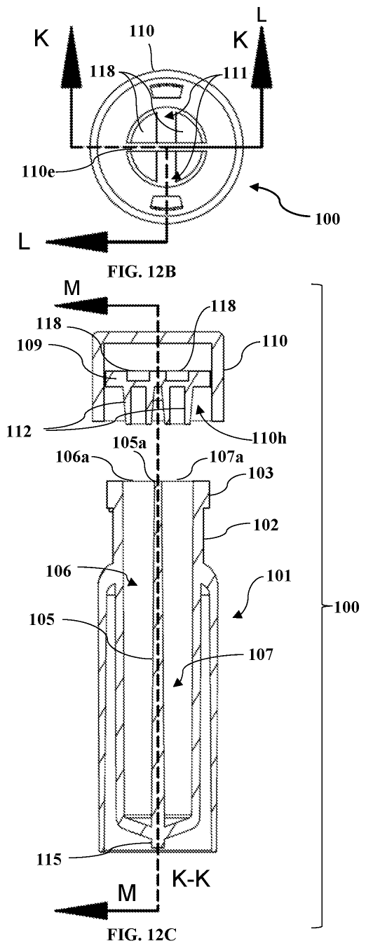

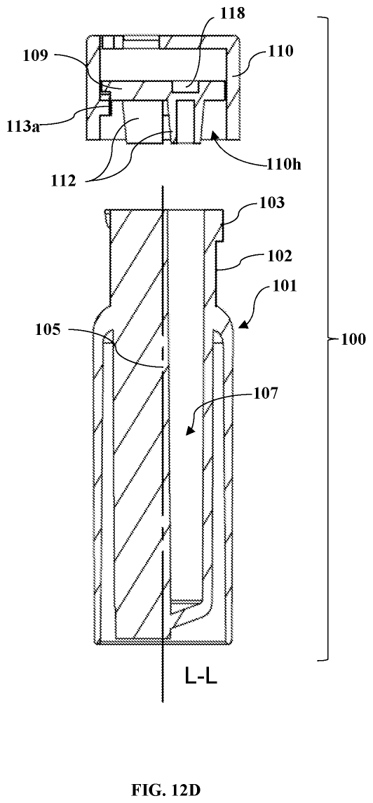

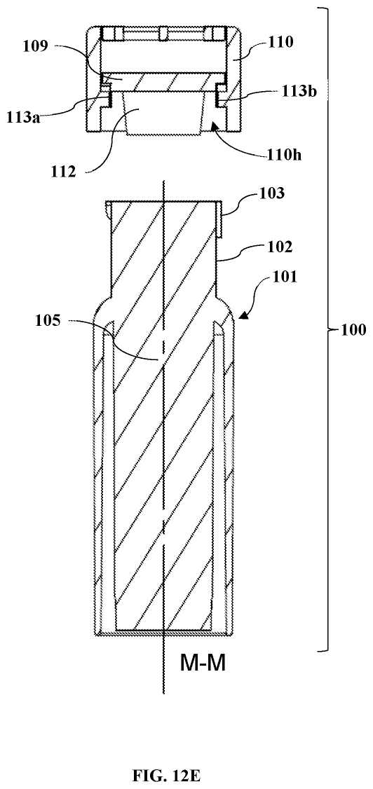

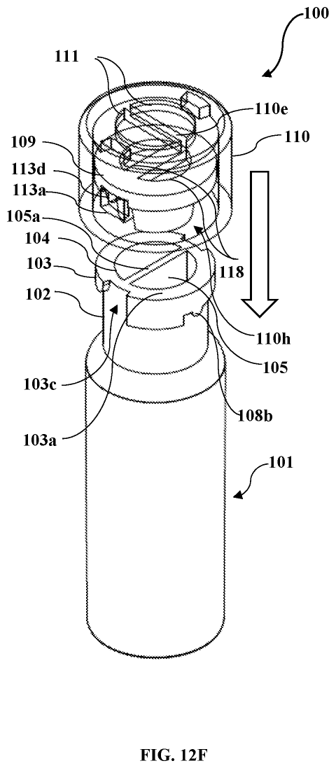

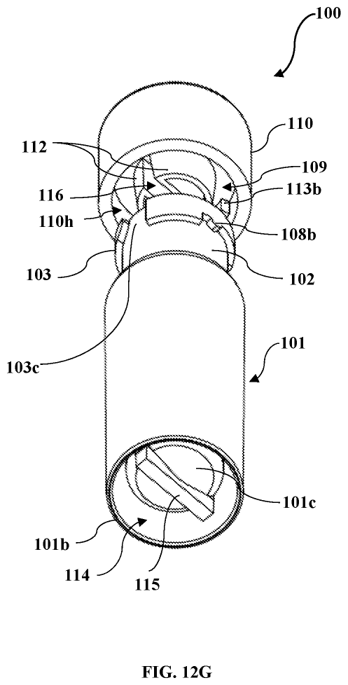

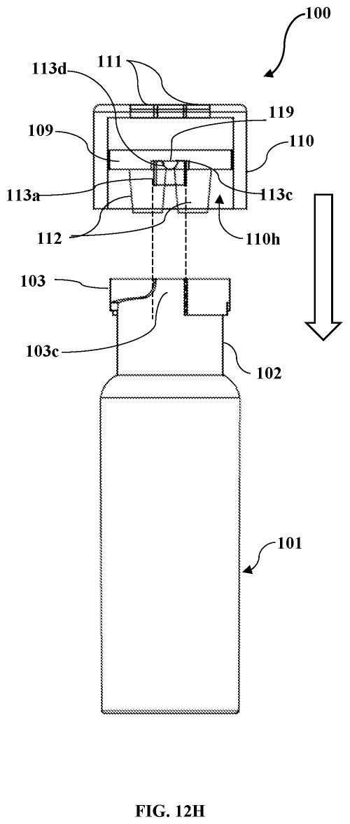

FIG. 7D illustrates a top plan view of the embodiment of the closure 110 shown in FIG. 7A. The top plan view in FIG. 7D illustrates the openings 111 configured on the upper end 110a of the closure 110. In an embodiment, the openings 111 of the closure 110 are left uncovered and define an open top of the closure 110. The two openings 111 of the closure 110 provide a visual of the orientation of the separate wells 106 and 107 of the container 101 illustrated in FIG. 1A and FIG. 1C. When the closure 110 is properly secured to the container 101 as illustrated in FIGS. 14C-14E, the partitioning element 110e that separates the two openings 111 of the closure 110 provides a visual indication of the location of the top end 105a of the interior wall 105 of the container 101 illustrated in FIGS. 12A-12C and FIG. 12F, and in turn, a visual indication of the separate wells 106 and 107 of the container 101. The partitioning element 110e of the closure 110 allows a user to visualize, at a glance from the top of the multi-volume vial apparatus 100 illustrated in FIG. 12A and FIG. 12F, the alignment of the top end 105a of the interior wall 105 of the container 101, and in turn, the separate wells 106 and 107 of the container 101, thereby assuring the user that the multi-volume vial apparatus 100 is assembled correctly and is ready for different operations to be performed thereon, for example, manually piercing the septa member 109 to enter the correct well 106 or 107. FIGS. 7E-7F illustrate cross-sectional views of the embodiment of the closure 110 shown in FIG. 7A, taken along sectional lines F-F and G-G, respectively, shown in FIG. 7D. The cross-sectional views in FIGS. 7E-7F illustrate the quarter-turn locking lugs 113a and 113b disposed on the inner surface 110i of the closure 110. In an embodiment, the closure 110 comprising the quarter-turn locking lugs 113a and 113b is configured as a quarter-turn cap.

FIG. 7G illustrates a bottom elevation view of the embodiment of the closure 110 shown in FIG. 7A. The bottom elevation view in FIG. 7G illustrates the openings 111 separated by the partitioning element 110e, and the quarter-turn locking lugs 113a and 113b of the closure 110.

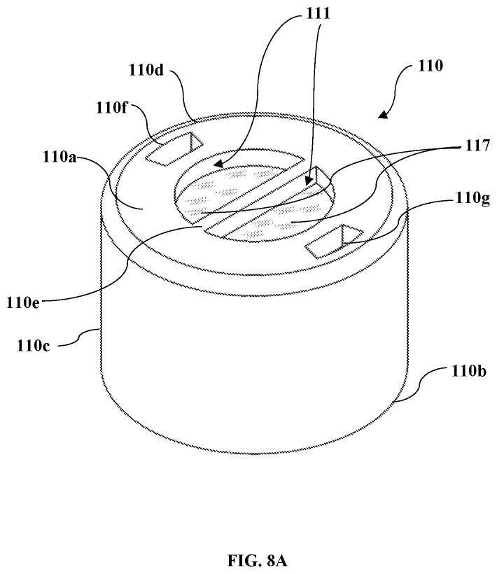

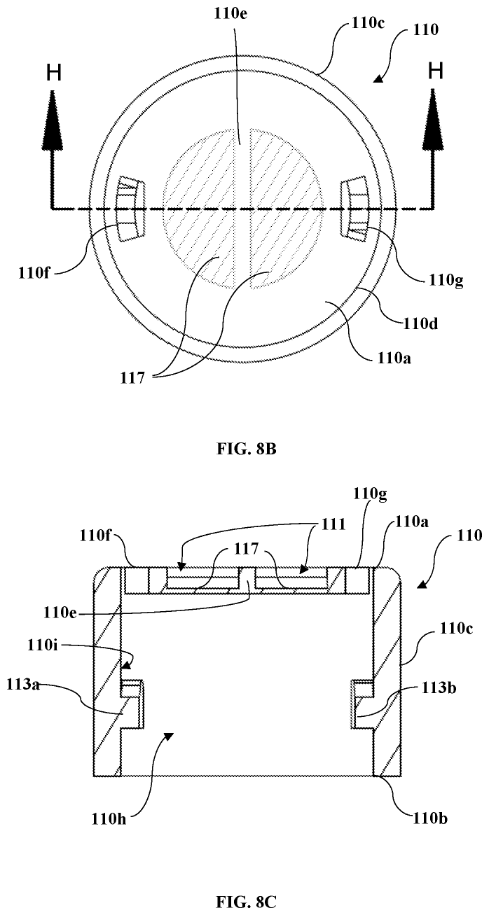

FIGS. 8A-8B illustrates a top perspective view and a top plan view of another embodiment of the closure 110, respectively. In this embodiment, the closure 110 further comprises a thin pierceable membrane 117 configured to close the two openings 111 of the closure 110 and allow penetration of one or more needles thereinto. In an embodiment, the two openings 111 of the closure 110 are molded with the pierceable membrane 117. In an embodiment, the thickness of the pierceable membrane 117 is about 0.008 inches to about 0.015 inches. The two openings 111 with the thin pierceable membrane 117 provide a visual of the orientation of the separate wells 106 and 107 of the container 101 illustrated in FIG. 1A and FIG. 1C. For example, the thin pierceable membrane 117 shows the D-shapes for determining the orientation of the separate wells 106 and 107 of the container 101.

FIG. 8C illustrates a cross-sectional view of the embodiment of the closure 110 shown in FIG. 8A, taken along a sectional line H-H shown in FIG. 8B. The cross-sectional view in FIG. 8C shows the pierceable membrane 117 closing the two openings 111 of the closure 110. In an embodiment, the pierceable membrane 117 is made from the same polymer used to manufacture the closure 110. The pierceable membrane 117 is molded as part of the closure 110 using the same polymeric material used to manufacture the closure 110. The pierceable membrane 117 is made from a polymeric material selected, for example, from polypropylene, polyethylene, polycarbonate, ethylene vinyl acetate (EVA), polyoxymethylene (POM), an acetal copolymer, etc. In another embodiment, the pierceable membrane 117 is made from a different polymer than that used to manufacture the closure 110. The pierceable membrane 117 maintains sterility of the samples contained in the container 101, when the closure 110 is closed over the collar 103 of the container 101 and seals the container 101 as illustrated in FIG. 2. The pierceable membrane 117 provides a barrier that prevents contamination of the samples contained in the container 101 from an ambient environment, which is required for pharmaceutical and biotechnological applications where sterile conditions need to be maintained to prevent microbial growth or contamination of sensitive substances, for example, drugs, vaccines, or biological samples. The pierceable membrane 117 protects the samples contained in the container 101 from exposure to air or contaminants during storage and transportation. The pierceable membrane 117 also provides a safety barrier that prevents accidental spillage of the samples or exposure to hazardous substances. The pierceable membrane 117 assists in containing the samples in the container 101 until the samples are accessed, for example, using a needle or a syringe. Furthermore, the pierceable membrane 117 allows for convenient and controlled access to the samples contained in the container 101, for example, using a needle or a syringe, which facilitates precise dosing or sampling without the need to remove the closure 110 of the multi-volume vial apparatus 100, thereby minimizing the risk of contamination or spillage.

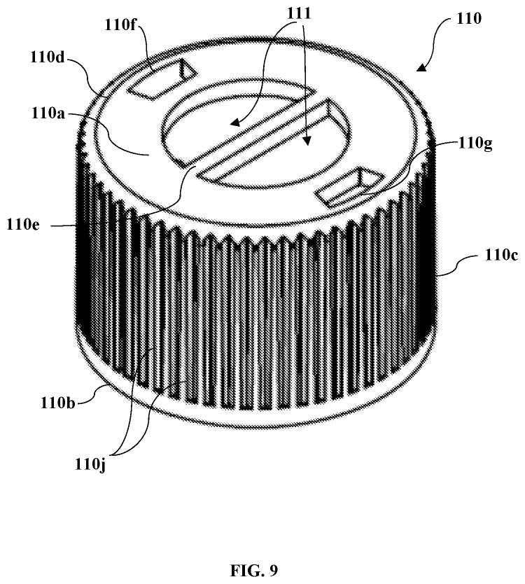

FIG. 9 illustrates a top perspective view of another embodiment of the closure 110. In this embodiment, the closure 110 is provided with a serrated surface 110j extending externally around the cylindrical wall 110c of the closure 110. The serrated surface 110j of the closure 110 provides an improved grip for manual capping of the container 101 or for a capping system (not shown) or a robotic arm of automated laboratory equipment, for example, an autosampler (not shown), to dispose the closure 110 on the collar 103 of the container 101 illustrated in FIGS. 3A-3C. For creating the serrated surface 110j for the closure 110, in an embodiment, a gripper arm (not shown) disposes and locks the closure 110 on the container 101 and then picks up a crimper and crimps the closure 110. In an embodiment, other gripping surfaces are configured externally around the cylindrical wall 110c of the closure 110 for providing an improved grip on the closure 110, for example, by hand or by the automated laboratory equipment.

FIGS. 10A-10B illustrate a top perspective view and a bottom perspective view of an embodiment of the septa member 109 of the multi-volume vial apparatus 100 shown in FIG. 1A, respectively. The septa member 109 is configured, for example, as an elastic or elastomeric seal that seals and maintains separation of the separate wells 106 and 107 of the container 101 illustrated in FIG. 1C and FIG. 3I. In an embodiment, the septa member 109 is made from a flexible material selected, for example, from silicone, butyl, ethylene-vinyl acetate (EVA), a thermoplastic elastomer (TPE), etc. In an embodiment, the septa member 109 is a generally disc-shaped or circular member comprising at least two opposing protruding sections 112 extending downwardly from the lower surface 109b of the septa member 109. In an example, for a dual-volume or dual-welled vial apparatus 100, the septa member 109 comprises two opposing protruding sections 112 configured to fit securely within the partitioned opening 104 of the collar 103 of the container 101 comprising two separate wells 106 and 107 illustrated in FIG. 1A and FIG. 1C. In an embodiment, the opposing protruding sections 112 of the septa member 109 are hollow, thereby facilitating flexibility of the opposing protruding sections 112 for insertion into the partitioned opening 104 of the collar 103 of the container 101. The groove 116 defined between the opposing protruding sections 112 is configured to mate with and firmly receive the top end 105a of the interior wall 105 of the container 101 as illustrated in FIG. 3I. In an embodiment, the septa member 109 comprises at least two recesses 118 disposed on an upper surface 109a of the septa member 109. The two recesses 118 are separated by a partitioning element 109d as illustrated in FIG. 10A. The two recesses 118 are configured to match the two opposing protruding sections 112 of the septa member 109 and the partitioned opening 104 of the collar 103 of the container 101. The two openings 111 of the closure 110 illustrated in FIG. 7A and FIG. 7D, are also configured to match the two recesses 118 of the septa member 109 and the partitioned opening 104 of the collar 103 of the container 101, in the locked condition of the container 101. The two openings 111 of the closure 110, the two recesses 118 of the septa member 109, the opposing protruding sections 112 of the septa member 109, and the partitioned opening 104 of the collar 103 of the container 101 are all oriented and aligned to match each other, in the locked condition of the container 101, for maintaining separation of the separate wells 106 and 107 of the container 101.

In an embodiment as illustrated in FIG. 10B, the opposing protruding sections 112 of the septa member 109 are configured as opposing D-shaped sections, where vertical lines 112a of the D-shaped sections are disposed to face each other. Similarly, in an embodiment as illustrated in FIG. 10A, the two recesses 118 of the septa member 109 are configured as opposing D-shaped sections that match the opposing protruding sections 112 of the septa member 109, the two openings 111 of the closure 110, and the D-shaped sections of the partitioned opening 104 of the collar 103 of the container 101, in the locked condition of the container 101. The number of recesses 118 of the septa member 109 is configured to be equal to the number of openings 111 of the closure 110 and the number of separate volumes defining separate wells in the container 101. For example, for a dual-volume vial apparatus 100 illustrated in FIGS. 1A-1D, two recesses 118 of the septa member 109 correspond to two openings 111 of the closure 110 and in turn, to two separate volumes defining two separate wells 106 and 107 in the container 101. In another example, for a triple-volume vial apparatus (not shown), three recesses 118 of the septa member 109 correspond to three openings 111 of the closure 110 and in turn, to three separate volumes defining three separate wells in the container 101. In another example, for a quadruple-volume vial apparatus (not shown), four recesses 118 of the septa member 109 correspond to four openings 111 of the closure 110 and in turn, to four separate volumes defining four separate wells in the container 101.

In an embodiment, the septa member 109 is configured as a pierceable seal that precludes escape of the samples from the separate wells 106 and 107 of the container 101. In an embodiment, when needles are inserted through the openings 111 of the closure 110, through the recesses 118 of the septa member 109, and then retracted, the recesses 118 close to preclude a risk of further sample liquid escaping inadvertently from the multi-volume vial apparatus 100 or of contaminants entering the multi-volume vial apparatus 100. In an embodiment, the septa member 109 further comprises at least two notches 119 disposed diametrically from a peripheral edge 109e of a circumferential wall 109c of the septa member 109 to the lower surface 109b of the septa member 109. The notches 119 are configured to mateably connect to the two quarter-turn locking lugs 113a and 113b of the closure 110 in the unlocked condition of the container 101 to allow the closure 110 to securely maintain the position of the septa member 109 as illustrated in FIGS. 11A-11B, FIG. 12H, and FIGS. 13A-13D.

In an example, the height of the septa member 109 including the opposing protruding sections 112 is about 0.26 inches; the diameter of the septa member 109 is about 0.512 inches; and the thickness of the septa member 109 is about 0.08 inches. In an example, the height of each of the opposing protruding sections 112 of the septa member 109 is about 0.18 inches, and the diameter of each of the opposing protruding sections 112 of the septa member 109 is about 0.346 inches. Each of the D-shaped opposing protruding sections 112 with a diameter of, for example, about 0.346 inches, is configured to interference fit by friction into each of the two opposing D-shaped sections of the partitioned opening 104 that define the upper ends 106a and 107a of the separate wells 106 and 107, respectively, with a diameter of about 0.343 inches. The shore A hardness of the septa member 109 as measured by a shore A durometer is in a range of, for example, about 35 to about 55. The shore A hardness of about 35 to about 55 allows the septa member 109 to deform and seal the edges of the partitioned opening 104 of the container 101 along their diameters or D-shapes.

FIG. 10C illustrates a top plan view of the embodiment of the septa member 109 shown in FIG. 10A. The top plan view in FIG. 10C illustrates the recesses 118 separated by the partitioning element 109d of the septa member 109. When the closure 110 is properly secured to the container 101, the recesses 118 of the septa member 109 are aligned to match the separate wells 106 and 107 of the container 101 illustrated in FIG. 1A, FIG. 12F, and FIG. 13A. That is, the recesses 118 of the septa member 109 provide a visual of the orientation of the separate wells 106 and 107 of the container 101 illustrated in FIG. 1A, FIG. 1C, FIG. 12F, and FIG. 13A. When the closure 110 is properly secured to the container 101, the partitioning element 109d that separates the recesses 118 of the septa member 109 serves as an orientation indicator that provides a visual indication of the location of the top end 105a of the interior wall 105 of the container 101, and in turn, a visual indication of the separate wells 106 and 107 of the container 101 illustrated in FIG. 12F and FIG. 13A. The partitioning element 109d of the septa member 109 allows a user to visualize, at a glance from the top of the multi-volume vial apparatus 100 illustrated in FIG. 12F, the alignment of the top end 105a of the interior wall 105 of the container 101, and in turn, the separate wells 106 and 107 of the container 101, thereby assuring the user that the multi-volume vial apparatus 100 is assembled correctly and is ready for different operations to be performed thereon, for example, manually piercing the septa member 109 to enter the correct well 106 or 107.

FIG. 10D illustrates a cross-sectional view of the embodiment of the septa member 109 shown in FIG. 10A, taken along a sectional line I-I shown in FIG. 10C. The cross-sectional view in FIG. 10D illustrates the opposing protruding sections 112 defining the groove 116 therebetween for mating with and firmly receiving the top end 105a of the interior wall 105 of the container 101 illustrated in FIG. 3I.

FIG. 10E illustrates a cross-sectional view of the embodiment of the septa member 109 shown in FIG. 10A, taken along a sectional line J-J shown in FIG. 10C. The cross-sectional view in FIG. 10E illustrates the notches 119 and one of the opposing protruding sections 112 of the septa member 109.

FIG. 10F illustrates a front elevation view of the embodiment of the septa member 109 shown in FIG. 10A. The front elevation view in FIG. 10F illustrates one of the notches 119 of the septa member 109 configured to mateably connect to one of the quarter-turn locking lugs 113a and 113b of the closure 110 as illustrated in FIGS. 11A-11B, FIG. 12H, and FIGS. 13B-13D.

FIG. 10G illustrates a bottom elevation view of the embodiment of the septa member 109 shown in FIG. 10A. The bottom elevation view in FIG. 10G illustrates the opposing protruding sections 112 and the notches 119 of the septa member 109 disposed on the lower surface 109b of the septa member 109.

FIG. 11A, FIG. 11B, and FIG. 11C illustrate a top perspective view, a front elevation view, and a top plan view, respectively, showing an embodiment of the closure 110 of the multi-volume vial apparatus 100 shown in FIG. 1A, enclosing the septa member 109 of the multi-volume vial apparatus 100. FIGS. 11A-11C provide a transparent view of the closure 110 showing internal aspects of the closure 110. To assemble the multi-volume vial apparatus 100, the septa member 109 is first enclosed within the inner cavity 110h of the closure 110 as illustrated in FIG. 11A, such that the notches 119 of the septa member 109 mateably connect to the quarter-turn locking lugs 113a and 113b disposed on the inner surface 110i of the closure 110 in an unlocked condition. FIGS. 11A-11B illustrate one of the notches 119 of the septa member 109 mateably connected to the quarter-turn locking lug 113a of the closure 110. The septa member 109 is disposed between the notch 110f and the quarter-turn locking lug 113a at one end of the septa member 109 and between the notch 110g and the quarter-turn locking lug 113b (not shown in FIG. 11A) at the diametrically opposite end of the septa member 109 within the inner cavity 110h of the closure 110. The notches 119 of the septa member 109 sit on the quarter-turn locking lugs 113a and 113b disposed on the inner surface 110i of the closure 110. That is, the top ends 113c of the quarter-turn locking lugs 113a and 113b fit within the notches 119 of the septa member 109 as illustrated in FIGS. 11A-11B. In an embodiment, in the partially assembled, unlocked condition, the openings 111 of the closure 110 are oriented, for example, about 90 degrees, with respect to the recesses 118 of the enclosed septa member 109 as illustrated in FIG. 11A and FIG. 11C.

FIG. 12A illustrates an exploded, top perspective view of a partially assembled, multi-volume vial apparatus 100. After enclosing the septa member 109 within the inner cavity 110h of the closure 110 as illustrated in FIGS. 11A-11C, the closure 110 with the enclosed septa member 109 is disposed over the collar 103 of the container 101 in an orientation as illustrated in FIG. 12A. In an embodiment, in the partially assembled, unlocked condition of the container 101, the openings 111 of the closure 110 are oriented, for example, about 90 degrees, with respect to the upper ends 106a and 107a of the separate wells 106 and 107, respectively, shown in FIG. 12C, that constitute the partitioned opening 104 on the collar 103 of the container 101 as illustrated in FIG. 12A.

FIG. 12B illustrates a top plan view of the partially assembled, multi-volume vial apparatus 100 shown in FIG. 12A. FIGS. 12C-12E illustrate cross-sectional views of the partially assembled, multi-volume vial apparatus 100 shown in FIG. 12A, taken along sectional lines K-K, L-L, and M-M shown in FIG. 12B and FIG. 12C. As illustrated in FIGS. 12C-12E, the septa member 109 is enclosed within the inner cavity 110h of the closure 110. The closure 110 with the enclosed septa member 109 is oriented over the collar 103 of the container 101, such that the recesses 118 and the opposing protruding sections 112 of the septa member 109 are aligned with the upper ends 106a and 107a of the separate wells 106 and 107, respectively.

FIG. 12F, FIG. 12G, and FIG. 12H illustrate a top perspective view, a bottom perspective view, and a front elevation view, respectively, showing movement of the closure 110 with the enclosed septa member 109 in a downward direction for placement over the collar 103 of the container 101 of the multi-volume vial apparatus 100. FIG. 12F and FIG. 12H provide a transparent view of the closure 110 showing internal aspects of the closure 110. Prior to placing the closure 110 with the enclosed septa member 109 over the collar 103 of the container 101, the quarter-turn locking lugs 113a and 113b of the closure 110 are aligned to fit within the diametrically opposite notches 103c of the collar 103 as indicated by dashed lines in FIG. 12H. After enclosing the septa member 109 within the inner cavity 110h of the closure 110 as illustrated in FIGS. 11A-11C and aligning the closure 110 with the enclosed septa member 109 over the collar 103 of the container 101 as illustrated in FIGS. 12A-12E, the closure 110 with the enclosed septa member 109 is moved or pressed in a downward direction or with one downward motion as illustrated in FIGS. 12F-12H, to close the container 101. When the opposing protruding sections 112 of the septa member 109 reach the top end 103a of the collar 103 of the container 101 illustrated in FIG. 12F, the groove 116 defined between the opposing protruding sections 112 of the septa member 109 illustrated in FIG. 12G receives the top end 105a of the interior wall 105 of the container 101. On further moving the closure 110 with the enclosed septa member 109 in the downward direction, the opposing protruding sections 112 of the septa member 109 mate with the top end 105a of the interior wall 105 and fit securely within the partitioned opening 104 of the collar 103 of the container 101. The notches 119 of the septa member 109 mateably connect to the quarter-turn locking lugs 113a and 113b of the closure 110 prior to locking the closure 110 on the collar 103 of the container 101.

FIGS. 13A-13B illustrate a top perspective view and a right-side elevation view of the embodiment of the multi-volume vial apparatus 100 shown in FIG. 1A, respectively, showing the placement of the closure 110 with the enclosed septa member 109 over the collar 103 of the container 101. FIGS. 13A-13B provide a transparent view of the closure 110 showing internal aspects of the closure 110. When the closure 110 with the enclosed septa member 109 is moved fully in the downward direction, the closure 110 closes over the collar 103 of the container 101, the opposing protruding sections 112 of the septa member 109 fit securely within the partitioned opening 104 of the collar 103 of the container 101, and the quarter-turn locking lugs 113a and 113b of the closure 110 fit within the diametrically opposite notches 103c of the collar 103 as illustrated in FIGS. 13A-13D. The container 101 closed by the closure 110 with its openings 111 oriented, for example, about 90 degrees, with respect to the recesses 118 of the septa member 109 as illustrated in FIG. 13A, and in turn, about 90 degrees with respect to the upper ends 106a and 107a of the separate wells 106 and 107 of the container 101, respectively, illustrated in FIG. 12F, is in an unlocked condition. The quarter-turn locking lugs 113a and 113b of the closure 110 lock the septa member 109 in position on the collar 103 of the container 101 and preclude displacement of the septa member 109 during locking and unlocking of the container 101 by rotation of the closure 110.

FIGS. 13C-13D illustrate a front elevation view and a rear elevation view of the embodiment of the multi-volume vial apparatus 100 shown in FIG. 13A, respectively, showing locking members 113a and 113b of the placed closure 110 seated in the notches 103c of the collar 103 of the container 101. Projected views N-N and O—O from FIG. 13A are illustrated in FIGS. 13C-13D, respectively. FIGS. 13C-13D also provide a transparent view of the closure 110 showing internal aspects of the closure 110. FIG. 13C illustrates the quarter-turn locking lug 113a of the closure 110 securely fit within one of the diametrically opposite notches 103c of the collar 103, and FIG. 13D illustrates the other quarter-turn locking lug 113b of the closure 110 securely fit within the other one of the diametrically opposite notches 103c of the collar 103, when the closure 110 with the enclosed septa member 109 is placed and closed over the collar 103 of the container 101, in the unlocked condition of the container 101.

FIGS. 14A-14B illustrate a top perspective view and a front elevation view of the embodiment of the multi-volume vial apparatus 100 shown in FIG. 1A, respectively, showing rotation of the closure 110 over the collar 103 of the container 101 for locking the container 101 without displacement of the septa member 109 on the collar 103 of the container 101. FIGS. 14A-14B provide a transparent view of the closure 110 showing internal aspects of the closure 110. To lock the container 101 with the septa member 109 secured into the partitioned opening 104 of the collar 103 of the container 101, the closure 110 is rotated, for example, about 90 degrees in a clockwise direction, without rotating the securely fit septa member 109, such that the quarter-turn locking lugs 113a and 113b of the closure 110 mate with and engage the quarter-turn locks 108a and 108b on the collar 103 of the container 101, respectively, as illustrated in FIGS. 14D-14E. In this locked condition of the container 101, the quarter-turn locking lugs 113a and 113b of the closure 110 have moved away from the diametrically opposite notches 103c of the collar 103 and are engaged with the quarter-turn locks 108a and 108b on the collar 103 of the container 101. Furthermore, in the locked condition of the container 101, after rotation, the openings 111 of the closure 110 are oriented to match the recesses 118 of the septa member 109, and in turn, to match the upper ends 106a and 107a of the separate wells 106 and 107 of the container 101, respectively, as illustrated in FIG. 1A.

FIG. 14C illustrates a front elevation view of the embodiment of the multi-volume vial apparatus 100 shown in FIG. 1A, showing the closure 110 with the securely fit septa member 109, in the locked condition on the collar 103 of the container 101. FIG. 14C provides a transparent view of the closure 110 showing internal aspects of the closure 110. Prior to closing and locking the closure 110 over the collar 103 of the container 101, the recesses 118 on the upper surface 109a of the septa member 109 are oriented to match the partitioned opening 104 of the collar 103, while being oriented in a direction about 90 degrees to the openings 111 on the upper end 110a of the closure 110 as illustrated in FIG. 12F and FIG. 13A. That is, when the notches 119 of the septa member 109 are disposed on the quarter-turn locking lugs 113a and 113b of the closure 110 in the unlocked condition of the container 101, the D-shaped recesses 118 and the D-shaped protruding sections 112 of the septa member 109 are in a direction about 90 degrees to the D-shaped openings 111 of the closure 110. When the closure 110 with the enclosed septa member 109 is disposed on the collar 103 of the container 101, the D-shaped protruding sections 112 of the septa member 109 first enter the partitioned opening 104 of the collar 103 of the container 101. When the closure 110 with the septa member 109 continues traveling in a downward direction, the septa member 109 reaches inside the top of the container 101 and seals the container 101. When the closure 110 and the septa member 109 are in a fully downward position that closes over the collar 103 of the container 101, the closure 110 is then quarter-turned by about 90 degrees, while the container 101 and the septa member 109 remains stationary. The closure 110 is quarter-turned by about 90 degrees to lock the closure 110 over the collar 103 of the container 101 without rotating the septa member 109 as illustrated in FIG. 14A.

FIGS. 14D-14E illustrate a left-side elevation view and a right-side elevation view of the embodiment of the multi-volume vial apparatus 100 shown in FIG. 14C, respectively, showing the closure 110 with the securely fit septa member 109, in the locked condition, and with the second locking members, that is, the quarter-turn locking lugs 113a and 113b, of the closure 110 engaged with the first locking members, that is, the quarter-turn locks 108a and 108b on the collar 103 of the container 101, respectively. Projected views P-P and Q-Q from FIG. 14C are illustrated in FIGS. 14D-14E, respectively. In an embodiment, each of the quarter-turn locking lugs 113a and 113b of the closure 110 comprises a generally semi-circular notch 113d illustrated in FIG. 12F, FIG. 12H, FIGS. 13C-13D, and FIGS. 14D-14E configured to mate with and engage the quarter-turn lock 108a or 108b configured on the circumferential wall 103b on the collar 103 of the container 101. In an embodiment, each of the quarter-turn locks 108a and 108b is a generally semi-circular tab configured to mate with and engage the semi-circular notch 113d of each of the quarter-turn locking lugs 113a and 113b of the closure 110. The semi-circular notch 113d of each of the quarter-turn locking lugs 113a and 113b is configured as a slot or a receptacle to receive the semi-circular tab of the quarter-turn lock 108a or 108b.

When the closure 110 with the enclosed septa member 109 is disposed on the collar 103 of the container 101 in the unlocked condition of the container 101, the quarter-turn locking lugs 113a and 113b of the closure 110 sit within the opposing notches 103c configured on the collar 103 of the container 101 as illustrated in FIGS. 13C-13D. In an embodiment, the opposing notches 103c configured on the collar 103 are of a rectangular shape configured to receive rectangular-shaped quarter-turn locking lugs 113a and 113b of the closure 110. The closure 110 is rotated by about 90 degrees, that is, a quarter of a full circle, for example, in a clockwise direction, without rotating the securely fit septa member 109, to engage the generally semi-circular notches 113d of the quarter-turn locking lugs 113a and 113b of the closure 110 with the generally semi-circular quarter-turn locks 108a and 108b on the collar 103 of the container 101, respectively, to lock the closure 110 over the container 101 as illustrated in FIGS. 14C-14E. After closing and locking the closure 110 over the collar 103 of the container 101, the D-shaped openings 111 on the upper end 110a of the closure 110 are oriented to match the recesses 118 on the upper surface 109a of the septa member 109 and the partitioned opening 104 of the collar 103. The closure 110 is unlocked from the container 101 by rotating the closure 110 by about 90 degrees in the opposite direction, for example, in a counterclockwise direction, without rotating the securely fit septa member 109, to disengage the generally semi-circular notches 113d of the quarter-turn locking lugs 113a and 113b of the closure 110 from the generally semi-circular quarter-turn locks 108a and 108b on the collar 103 of the container 101, respectively. The quarter-turn of the closure 110 in opposite directions provides a low removal torque to conveniently lock and unlock the closure 110.

For purposes of illustration, the disclosure herein refers to two notches 119 of the septa member 109 configured to sit on two quarter-turn locking lugs 113a and 113b of the closure 110, which are in turn configured to sit within two opposing notches 103c configured on the collar 103 of the container 101; however, the scope of the multi-volume vial apparatus 100 disclosed herein is not limited to two notches 119 of the septa member 109, two quarter-turn locking lugs 113a and 113b, and two opposing notches 103c of the collar 103, but extends to include any configurable number of notches 119, quarter-turn locking lugs 113a and 113b, and opposing notches 103c that are configured to securely seal and close the container 101 of the multi-volume vial apparatus 100.

FIG. 15 illustrates a top perspective view of an embodiment of an automated laboratory assembly 1500, showing an exploded, top perspective view of the embodiment of the multi-volume vial apparatus 100 shown in FIG. 1A. The automated laboratory assembly 1500 comprises the multi-volume vial apparatus 100 as disclosed in the descriptions of FIGS. 1A-1D and FIG. 2, and a plate member 1501. The plate member 1501 comprises multiple receptacles 1502. Each of the receptacles 1502 comprises a mating notch 1503 configured to receive and engage with the protruding element 115 of the multi-volume vial apparatus 100 illustrated in FIG. 1B, FIG. 3B, and FIG. 3F, for positioning, holding, and securing the container 101 of the multi-volume vial apparatus 100 in position within each of the receptacles 1502 to preclude rotation of the container 101 during multiple operations performed on the container 101. In an embodiment, the mating notch 1503 is configured within a raised portion 1504 of each receptacle 1502. In an example, the height of the raised portion 1504 of each receptacle 1502 is about 0.125 inches. When the multi-volume vial apparatus 100 is disposed in the receptacle 1502 of the plate member 1501, the protruding element 115 of the multi-volume vial apparatus 100 is engaged with the mating notch 1503 of the receptacle 1502 of the plate member 1501, and is also aligned with the top end 105a of the interior wall 105 of the container 101 and the partitioning element 109d of the septa member 109, which presents the locations and orientation of the separate wells 106 and 107 of the container 101 to probe heads of automation laboratory equipment. The protruding element 115 of the multi-volume vial apparatus 100, when engaged with the mating notch 1503 of the receptacle 1502 of the plate member 1501, securely holds and restricts the container 101 from turning while an operation, for example, removing the closure 110 on the container 101, placing the closure 110 on the container 101, applying or reading barcode labels on the container 101, etc., is being performed. High-resolution charge coupled device (CCD) barcode reading comprising two-dimensional (2D) barcode reading of the plate member 1501 and the multi-volume vial apparatuses 100 allows a user to track and store information related to the samples contained in the multi-volume vial apparatuses 100. The protruding element 115 of the multi-volume vial apparatus 100, when engaged with the mating notch 1503 of the receptacle 1502 of the plate member 1501, allows the probe heads of the automated laboratory equipment to properly locate the separate wells 106 and 107 of the container 101.

To prevent evaporation and to minimize exposure to air, reagents contained in the multi-volume vial apparatuses 100 are capped with their respective closures 110 on the plate member 1501. For capping, each multi-volume vial apparatus 100 is transported to a capping station (not shown) where the closure 110 can be either removed or locked into place. The closures 110 can either be stored before or after capping and de-capping on a workbench or discarded after de-capping. In an embodiment, an integrated capping station disposes and locks the closures 110 onto the respective multi-volume vial apparatuses 100 on the plate member 1501, thereby allowing the whole plate member 1501 to be placed onto an autosampler.

FIGS. 16A-16B illustrate a top perspective view and a front elevation view of an embodiment of the plate member 1501 of the automated laboratory assembly 1500, respectively, shown in FIG. 15. In an embodiment, the plate member 1501 is an automation plate, for example, a microplate, an automation carrier plate, or a vial tray used in an autosampler. The plate member 1501 is, for example, an American National Standards Institute (ANSI)/Society for Laboratory Automation and Screening (SLAS) microplate. The plate member 1501 is, for example, of a generally rectangular shape as illustrated in FIG. 16A. The plate member 1501 is configured to hold multiple multi-volume vial apparatuses 100 illustrated in FIG. 15, within the receptacles 1502. The receptacles 1502 are, for example, of a generally circular shape. The plate member 1501 is sized according to the number of receptacles 1502 required. The receptacles 1502 are arranged in the plate member 1501, for example, in patterns of 6, 8, 12, 24, 48, or 96 receptacles. The receptacles 1502 are sized to receive and accommodate multiple multi-volume vial apparatuses 100 of the same size or of different sizes. Multi-volume vial apparatuses 100 of varying diameters require a particular number of receptacles 1502 within the plate member 1501. The blade-like protruding element 115 of each multi-volume vial apparatus 100 illustrated in FIG. 1B, FIG. 3B, and FIG. 3F, is positioned within the mating notch 1503 of one of the receptacles 1502. The plate member 1501 of the automated laboratory assembly 1500 is manufactured, for example, using 3D prototype printing, injection compression molding, conventional machining equipment, etc. The plate member 1501 is made of a material selected, for example, from aluminum, stainless steel, and resins such as polypropylene, acrylonitrile butadiene styrene (ABS), polyethylene, polycarbonate, nylon, cyclic olefin copolymer (COC), etc.

FIG. 16C illustrates a top plan view of the embodiment of the plate member 1501 shown in FIG. 16A. The top plan view in FIG. 16C illustrates the generally circular-shaped receptacles 1502 comprising mating notches 1503 for receiving the blade-like protruding elements 115 attached to the bases 101c of the containers 101 of the multi-volume vial apparatuses 100 illustrated in FIG. 1B, FIG. 3B, and FIG. 3F. In an example, the length and the width of the plate member 1501 with about 24 receptacles 1502 are about 5.03 inches and 3.365 inches, respectively. In an example, the width of the mating notch 1503 of the receptacle 1502 that receives the blade-like protruding element 115 of the container 101 is about 0.1 inch. The size of each receptacle 1502 is configured to accommodate a multi-volume vial apparatus 100 of any size.

FIG. 16D illustrates a cross-sectional view of the embodiment of the plate member 1501 shown in FIG. 16A, taken along a sectional line R-R shown in FIG. 16C. The cross-sectional view in FIG. 16D illustrates the mating notches 1503 defined within the raised portions 1504 of the receptacles 1502 of the plate member 1501.

Consider an example where a user loads multiple multi-volume vial apparatuses 100, each containing at least two samples, onto the plate member 1501 of an autosampler for performing a high-pressure liquid chromatography (HPLC) or liquid chromatography-mass spectrometry (LC/MS) analysis. Samples for an HPLC or LC/MS analysis can be taken at any given time during the process. There are different methods for preparing the samples for the HPLC or LC/MS analysis. For example, samples can be filtered from the top using filter probes and transferred directly into the multi-volume vial apparatuses 100. In another example, aliquots are removed directly from eluant multi-volume vial apparatuses 100 following filtration. In another example, samples are transferred into the multi-volume vial apparatuses 100 using a substantially thin, beveled HPLC probe to pierce through the septa member 109 of the multi-volume vial apparatuses 100.

The user loads each multi-volume vial apparatus 100 by positioning the blade-like protruding element 115 at the bottom end 101b of each container 101 into the mating notch 1503 of a corresponding receptacle 1502 in the plate member 1501. The multi-volume vial apparatuses 100 are arranged in a particular order or pattern on the plate member 1501 according to a sampling sequence defined by the user or an analytical method being employed. The autosampler positions two sampling needles or probes above the first multi-volume vial apparatus 100 in the sampling sequence, for example, using motorized mechanisms that allow precise movement of the sampling probes in three dimensions, that is, X, Y, and Z axes. Examples of sampling probes comprise multi-channel probes, temperature-controlled probes, ceramic and specially coated probes, slurry probes, piercing probes, spotting probes, spraying probes, filtration probes, pH probes, etc. The autosampler lowers the sampling probes into the separate wells 106 and 107 of the first multi-volume vial apparatus 100 through the openings 111 of the closure 110 and in turn through the recesses 118 of the septa member 109 illustrated in FIG. 15, to collect two different samples contained in the separate wells 106 and 107 in a single operation. After the sampling probes collect the two samples, the autosampler withdraws the sampling probes from the multi-volume vial apparatus 100, ensuring that the samples are retained within the sampling probes for injection into an analytical instrument. The autosampler transports the sampling probes to an injection port or inlet of the analytical instrument, where the samples will be injected for analysis. Once the sampling probes are properly positioned at the injection port, the autosampler injects the samples into the analytical instrument for analysis. The injection process may be automated and controlled by software of the analytical instrument. The above steps are repeated sequentially for each multi-volume vial apparatus 100 in the sampling sequence until all samples have been analyzed or until the user-defined analysis run is completed.

As opposed to conventional autosamplers that allow one injection or probe into a single vial, the multi-volume vial apparatus 100 produces an increase in the throughput, for example, double the throughput, triple the throughput, quadruple the throughput, etc., in the same single operation without changing the industry standard pitch spacing of the plate member 1501 and within the same footprint of the vial area. Furthermore, the multi-volume vial apparatus 100 allows two or more separate analyses to be run within the same multi-volume vial apparatus 100 in the same operation or in an alternative operation. In an embodiment, the multi-volume vial apparatus 100 is used without the closure 110 and the septa member 109, as required. The multi-volume vial apparatus 100 is also used for individual laboratory use, while doubling or increasing the analytical results in less time and with less handling.

FIG. 17 illustrates a flowchart of an embodiment of a method for assembling a multi-volume vial apparatus 100. In the method disclosed herein, a container 101 defining an inner volume and comprising a neck 102, a collar 103, at least one interior wall 105, and two or more first locking members 108a and 108b as illustrated in FIGS. 3A-6C and as disclosed in the descriptions of FIGS. 3A-6C, is provided 1701. Furthermore, a septa member 109 configured to seal and maintain separation of the separate wells 106 and 107 of the container 101 as illustrated in FIGS. 10A-10G and as disclosed in the descriptions of FIGS. 10A-10G, is provided 1702. Furthermore, a closure 110 comprising two second locking members 113a and 113b disposed diametrically on the inner surface 110i of the closure 110 as illustrated in FIGS. 7A-7G and FIGS. 8A-8C and as disclosed in the descriptions of FIGS. 7A-7G and FIGS. 8A-8C, is provided 1703. The septa member 109 is enclosed 1704 within the inner cavity 110h of the closure 110, such that the notches 119 of the septa member 109 mateably connect to the second locking members 113a and 113b of the closure 110 as illustrated in FIGS. 11A-11C. The closure 110 with the enclosed septa member 109 is disposed and moved 1705 on the top end 103a of the collar 103 of the container 101 in a downward direction to fit the opposing protruding sections 112 of the septa member 109 securely within the partitioned opening 104 of the collar 103 of the container 101, such that the groove 116 between the opposing protruding sections 112 of the septa member 109 mates with and firmly receives the top end 105a of the interior wall 105 of the container 101 illustrated in FIG. 12F and FIG. 12H. The closure 110 covers the collar 103 of the container 101 as illustrated in FIGS. 13A-13D. The closure 110 is rotated 1706 over the collar 103 of the container 101 as illustrated in FIGS. 14A-14B, to engage the second locking members 113a and 113b of the closure 110 with the first locking members 108a and 108b on the collar 103 of the container 101 to lock the container 101, while securely maintaining orientation of the septa member 109 on the partitioned opening 104 of the collar 103 of the container 101.

In the unlocked condition of the container 101, the openings 111 of the closure 110 are oriented about 90 degrees with respect to the recesses 118 of the septa member 109 as illustrated in FIG. 13A. In the locked condition of the container 101, the openings 111 of the closure 110 are oriented and aligned to match the recesses 118 of the septa member 109 and the partitioned opening 104 of the collar 103 of the container 101 as illustrated in FIG. 1A and FIG. 15. In the locked condition, the D-shaped sections, that is, the openings 111 of the closure 110, the recesses 118 of the septa member 109, and the partitioned opening 104 of the collar 103 of the container 101 are all in the same orientation and aligned to match each other as illustrated in FIG. 1A and FIG. 15.

The multi-volume vial apparatus 100 disclosed herein allows simultaneous and separate withdrawal of the samples from the separate wells 106 and 107 of the container 101. Furthermore, the partitioning interior wall 105 of the multi-volume vial apparatus 100 is arranged symmetrically in relation to the partitioning elements 109d and 110e of the septa member 109 and the closure 110, respectively, in the locked condition of the container 101. The partitioning interior wall 105 creates two or more separate volumes within a single volume container 101, and the septa member 109 maintains separation of the multiple volumes within the container 101. The multi-volume vial apparatus 100 used, for example, in a sampling process executed by an autosampler, defines an inner volume partitioned into at least two separate volumes defining separate wells 106 and 107 for containing samples. The multi-volume vial apparatus 100 allows for multiple parallel analyses and parallel syntheses to be performed within the same multi-volume vial apparatus 100. The sampling process with the multi-volume vial apparatus 100 produces an increased throughput in a short amount of time with less handling for analyzing multiple samples and improved results. Moreover, to prevent leakage from the multi-volume vial apparatus 100, the quarter-turn locking lugs 113a and 113b of the closure 110 engage with the quarter-turn locks 108a and 108b on the collar 103 of the container 101, respectively, and lock the container 101 of the multi-volume vial apparatus 100, by a quarter-turn of the closure 110 as illustrated in FIGS. 14A-14E, without displacing the septa member 109, which improves the closing of the container 101 and removal of the closure 110 from the container 101 during the sampling process. Furthermore, the closure 110 securely maintains the orientation of the enclosed septa member 109 on the partitioned opening 104 of the collar 103 of the container 101, thereby allowing the septa member 109 to seal the separate wells 106 and 107 of the container 101 individually.

The notches 119 of the septa member 109 mateably connect to the quarter-turn locking lugs 113a and 113b of the closure 110 as illustrated in FIGS. 13A-13D, prior to locking the closure 110 on the collar 103 of the container 101, that is, in the unlocked condition of the container 101. The closure 110 rotates and locks the connected septa member 109 in position on the collar 103 of the container 101 by engagement of the quarter-turn locking lugs 113a and 113b of the closure 110 with the quarter-turn locks 108a and 108b on the collar 103 of the container 101, respectively, thereby precluding displacement of the septa member 109 and preventing leakage of the samples in the separate wells 106 and 107 of the container 101, which precludes the contamination of the samples and loss of material required in the analyses, thereby improving qualitative and/or quantitative results of the analyses. The closure 110 and the locking members 113a, 113b and 108a, 108b of the multi-volume vial apparatus 100 allow convenient closure and access to multiple samples in a single multi-volume vial apparatus 100 without displacing the septa member 109 from the top end 103a of the collar 103 of the container 101.

The closure 110 configured as a quarter-turn cap allows the septa member 109 to be oriented to seal the separate wells 106 and 107 of the container 101 individually, allowing the closure 110 to turn and lock the container 101, while keeping the septa member 109 in position. The closure 110 configured as a quarter-turn cap provides a maximum turn stop without over-torquing and displacing the septa member 109 while providing a uniform seal that prevents leakage of the samples from the container 101 which typically occurs when a standard screw thread is used. When the quarter-turn locking lugs 113a and 113b of the closure 110 are engaged with the generally semi-circular quarter-turn locks 108a and 108b on the collar 103 of the container 101, respectively, to lock the closure 110 over the container 101, the quarter-turn locks 108a and 108b provide a uniform height of the closure 110 over the container 101 as opposed to screw threads of conventional vials that cause their caps to be over or under tightened on the vials causing height differences when assembled and also causing misalignment or misorientation of scal ports of the caps, making it difficult for probe heads of the automated laboratory equipment to identify the location of the seal ports to perform different operations for a sample analysis. The closed and locked container 101, therefore, has a uniform height, that maintains orientation and uniform alignment of the openings 111 of the closure 110, the recesses 118 of the septa member 109, and the partitioned opening 104 of the container 101, thereby providing convenient access of the samples contained in the separate wells 106 and 107 of the container 101 to the probe heads of the automated laboratory equipment.

The single or multiple blade-like protruding elements 115 at the bottom end 101b of the container 101 are configured to lock the container 101 of the multi-volume vial apparatus 100 in position in the receptacle 1502 of the plate member 1501 of the automated laboratory assembly 1500 to prevent rotation of the container 101 during performance of different operations on the container 101, for example, placing the closure 110 on the container 101, removing the closure 110 from the container 101, applying labels such as barcode labels on the container 101, reading labels on the container 101, etc., or for use in automation equipment. The single or multiple blade-like protruding elements 115 at the bottom end 101b of the container 101 indicates the orientation of the interior wall 105, and in turn, the separate wells 106 and 107 of the container 101, thereby presenting the separate volumes of the container 101 for convenient access by automated laboratory equipment probes during a sampling process and allowing the throughput of the sampling process to be increased. In an embodiment, the single or multiple blade-like protruding elements 115 at the bottom end 101b of the container 101 are configured to lock the container 101 to the mating notch 1503 of the receptacle 1502 of the plate member 1501. In the locked condition, the multi-volume vial apparatus 100 visually indicates the orientation and the locations of the openings 111 of the closure 110, the recesses 118 of the septa member 109, and the partitioned opening 104 of the container 101, thereby allowing the automated equipment laboratory probes to accurately access the samples contained therein, which allows the throughput of the sampling process to be increased. The container 101, the septa member 109, and the closure 110 of the multi-volume vial apparatus 100 are substantially scalable and are configured to broaden the sales market to multiple specific applications.

The foregoing examples and illustrative implementations of various embodiments have been provided merely for explanation and are in no way to be construed as limiting the embodiments disclosed herein. Dimensions of various parts of the multi-volume vial apparatus disclosed above are exemplary, and are not limiting of the scope of the embodiments herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

We claim:

1. A multi-volume vial apparatus comprising:
a container defining an inner volume, the container comprising:
a neck extending from an upper end of the container;
a collar comprising an opening, disposed on an upper end of the neck;
at least one interior wall extending from a top end of the collar to a bottom end of the container, wherein the at least one interior wall is configured to partition the inner volume into separate volumes defining separate wells for containing samples, and wherein the opening of the collar is partitioned by a top end of the at least one interior wall to provide separate access to the separate wells; and
two or more first locking members configured diametrically on a circumferential wall of the collar of the container;
a septa member configured to be enclosed within an inner cavity of a closure and disposed on the top end of the collar of the container to seal and maintain separation of the separate wells of the container, wherein the septa member comprises at least two opposing protruding sections extending downwardly from a lower surface of the septa member and configured to fit securely within the partitioned opening of the collar of the container, and wherein the at least two opposing protruding sections define a groove therebetween configured to mate with and firmly receive the top end of the at least one interior wall of the container; and
the closure configured to enclose the septa member and cover the collar of the container, wherein the closure comprises two or more second locking members disposed diametrically on an inner surface of the closure, wherein the two or more second locking members of the closure are configured to engage with the two or more first locking members on the collar of the container to lock the container.

2. The multi-volume vial apparatus of claim 1, wherein the collar of the container comprises notches diametrically disposed on opposing sides of the at least one interior wall, wherein the notches are configured to receive and seat the two or more second locking members of the closure in an unlocked condition of the container.

3. The multi-volume vial apparatus of claim 1, wherein the septa member comprises at least two recesses disposed on an upper surface of the septa member and configured to match the at least two opposing protruding sections of the septa member and the partitioned opening of the collar of the container.

4. The multi-volume vial apparatus of claim 3, wherein the closure further comprises at least two openings configured to match the at least two recesses of the septa member and the partitioned opening of the collar of the container.

5. The multi-volume vial apparatus of claim 4, wherein the closure further comprises a pierceable membrane configured to close the at least two openings of the closure and allow penetration of one or more needles thereinto.

6. The multi-volume vial apparatus of claim 1, wherein the septa member further comprises at least two notches disposed diametrically from a peripheral edge of the septa member to the lower surface of the septa member, wherein the at least two notches are configured to mateably connect to the two or more second locking members of the closure in an unlocked condition of the container.

7. The multi-volume vial apparatus of claim 1, wherein the closure is configured to:
allow the at least two opposing protruding sections of the enclosed septa member to be oriented to seal the separate wells of the container individually;
rotate and lock the septa member in position on the collar of the container by engagement of the two or more second locking members of the closure with the two or more first locking members on the collar of the container; and
perform a maximum turn stop without over-torquing and displacing the septa member while providing a uniform seal, preventing leakage of the samples contained in the separate wells of the container, and providing a visual indication of locations of the separate wells in the container.

8. The multi-volume vial apparatus of claim 1, wherein the separate wells of the container are tapered to reduce their separate volumes.

9. The multi-volume vial apparatus of claim 1, wherein the separate wells of the container are configured to receive glass inserts.

10. The multi-volume vial apparatus of claim 1, wherein a bottom end of each of the separate wells of the container is configured in one or more of a plurality of shapes for substantial recovery of the samples contained therein, wherein the plurality of shapes comprises a conical shape, a rounded shape, a flat shape, and a pointed shape.

11. The multi-volume vial apparatus of claim 1, wherein the at least two opposing protruding sections of the septa member are D-shaped sections, wherein vertical lines of the D-shaped sections are disposed to face each other.

12. The multi-volume vial apparatus of claim 1, wherein the two or more first locking members on the collar of the container are quarter-turn locks with a maximum turn stop position, and wherein the two or more second locking members of the closure are quarter-turn locking lugs configured to engage with the quarter-turn locks on the collar of the container and lock the container by a quarter-turn of the closure on the collar of the container, without displacing the septa member on the collar of the container.

13. The multi-volume vial apparatus of claim 1, further comprising one or more protruding elements attached to the bottom end of the container, wherein the one or more protruding elements are configured to engage with a mating notch of a receptacle disposed in a plate member of automated laboratory equipment for positioning, holding, and securing the container in position within the receptacle to preclude rotation of the container during a plurality of operations performed on the container, and wherein the one or more protruding elements are configured to indicate locations of the separate wells partitioned by the at least one interior wall of the container.

14. The multi-volume vial apparatus of claim 13, wherein the bottom end of the container comprises a cavity for housing the one or more protruding elements in the container.

15. The multi-volume vial apparatus of claim 1, wherein the container is a generally cylindrical member, and wherein the septa member is a disc-shaped member.

16. The multi-volume vial apparatus of claim 1 configured to be used free of the septa member and the closure.

17. An automated laboratory assembly comprising:
a multi-volume vial apparatus comprising:
a container defining an inner volume, the container comprising:
a neck extending from an upper end of the container;
a collar comprising an opening, disposed on an upper end of the neck;
at least one interior wall extending from a top end of the collar to a bottom end of the container, wherein the at least one interior wall is configured to partition the inner volume into separate volumes defining separate wells for containing samples, and wherein the opening of the collar is partitioned by a top end of the at least one interior wall to provide separate access to the separate wells; and
two or more first locking members configured diametrically on a circumferential wall of the collar of the container;
a septa member configured to be enclosed within an inner cavity of a closure and disposed on the top end of the collar of the container to seal and maintain separation of the separate wells of the container, wherein the septa member comprises at least two opposing protruding sections extending downwardly from a lower surface of the septa member and configured to fit securely within the partitioned opening of the collar of the container, and wherein the at least two opposing protruding sections define a groove therebetween configured to mate with and firmly receive the top end of the at least one interior wall of the container;
the closure configured to enclose the septa member and cover the collar of the container, wherein the closure comprises two or more second locking members disposed diametrically on an inner surface of the closure, wherein the two or more second locking members of the closure are configured to engage with the two or more first locking members on the collar of the container to lock the container; and
one or more protruding elements attached to the bottom end of the container; and
a plate member comprising a plurality of receptacles, wherein each of the receptacles comprises a mating notch configured to receive and engage with the one or more protruding elements of the multi-volume vial apparatus for positioning, holding, and securing the container of the multi-volume vial apparatus in position within the each of the receptacles to preclude rotation of the container during a plurality of operations performed on the container, and wherein the one or more protruding elements are configured to indicate locations of the separate wells partitioned by the at least one interior wall of the container.

18. The automated laboratory assembly of claim 17, wherein the collar of the container of the multi-volume vial apparatus comprises notches diametrically disposed on opposing sides of the at least one interior wall, wherein the notches are configured to receive and seat the two or more second locking members of the closure in an unlocked condition of the container.

19. The automated laboratory assembly of claim 17, wherein the septa member of the multi-volume vial apparatus comprises at least two recesses disposed on an upper surface of the septa member and configured to match the at least two opposing protruding sections of the septa member and the partitioned opening of the collar of the container.

20. The automated laboratory assembly of claim 19, wherein the closure of the multi-volume vial apparatus further comprises at least two openings configured to match the at least two recesses of the septa member and the partitioned opening of the collar of the container.

21. The automated laboratory assembly of claim 20, wherein the closure further comprises a pierceable membrane configured to close the at least two openings of the closure and allow penetration of one or more needles thereinto.

22. The automated laboratory assembly of claim 17, wherein the septa member of the multi-volume vial apparatus further comprises at least two notches disposed diametrically from a peripheral edge of the septa member to the lower surface of the septa member, wherein the at least two notches are configured to mateably connect to the two or more second locking members of the closure in an unlocked condition of the container.

23. The automated laboratory assembly of claim 17, wherein the separate wells of the container of the multi-volume vial apparatus are tapered to reduce their separate volumes, wherein the separate wells of the container are configured to receive glass inserts, and wherein a bottom end of each of the separate wells of the container is configured in one or more of a plurality of shapes for substantial recovery of the samples contained therein, wherein the plurality of shapes comprises a conical shape, a rounded shape, a flat shape, and a pointed shape.

24. The automated laboratory assembly of claim 17, wherein the two or more first locking member on the collar of the container of the multi-volume vial apparatus are quarter-turn locks with a maximum turn stop position, and wherein the two or more second locking members of the closure of the multi-volume vial apparatus are quarter-turn locking lugs configured to engage with the quarter-turn locks on the collar of the container and lock the container by a quarter-turn of the closure on the collar of the container, without displacing the septa member on the collar of the container.

25. A method for assembling a multi-volume vial apparatus, the method comprising:
providing a container defining an inner volume, the container comprising:
a neck extending from an upper end of the container;
a collar comprising an opening, disposed on an upper end of the neck;
at least one interior wall extending from a top end of the collar to a bottom end of the container, wherein the at least one interior wall is configured to partition the inner volume into separate volumes defining separate wells for containing samples, and wherein the opening of the collar is partitioned by a top end of the at least one interior wall to provide separate access to the separate wells; and
two or more first locking members configured diametrically on a circumferential wall of the collar of the container;
providing a septa member configured to seal and maintain separation of the separate wells of the container, wherein the septa member comprises:
at least two opposing protruding sections extending downwardly from a lower surface of the septa member, wherein the at least two opposing protruding sections define a groove therebetween; and
at least two notches disposed diametrically from a peripheral edge of the septa member to the lower surface of the septa member;
providing a closure comprising two or more second locking members disposed diametrically on an inner surface of the closure;
enclosing the septa member within an inner cavity of the closure, wherein the at least two notches of the septa member mateably connect to the two or more second locking members of the closure;
disposing and moving the closure with the enclosed septa member on the top end of the collar of the container in a downward direction to fit the at least two opposing protruding sections of the septa member securely within the partitioned opening of the collar of the container, such that the groove between the at least two opposing protruding sections of the septa member mates with and firmly receives the top end of the at least one interior wall of the container; and
rotating the closure over the collar of the container to engage the two or more second locking members of the closure with the two or more first locking members on the collar of the container to lock the container, while securely maintaining orientation of the septa member on the partitioned opening of the collar of the container.

26. The method of claim 25, wherein the septa member comprises at least two recesses disposed on an upper surface of the septa member and configured to match the at least two opposing protruding sections of the septa member and the partitioned opening of the collar of the container, and wherein the closure further comprises at least two openings configured to be oriented about 90 degrees to the at least two recesses of the septa member in an unlocked condition of the container and to match the at least two recesses of the septa member and the partitioned opening of the collar of the container in a locked condition of the container.

27. The method of claim 25, wherein the closure is configured to:
allow the at least two opposing protruding sections of the enclosed septa member to be oriented to seal the separate wells of the container individually;
rotate and lock the septa member in position on the collar of the container by engagement of the two or more second locking members of the closure with the two or more first locking members on the collar of the container; and
perform a maximum turn stop without over-torquing and displacing the septa member while providing a uniform seal, preventing leakage of the samples contained in the separate wells of the container, and providing a visual indication of locations of the separate wells in the container.
